(19) United States
(12) Patent Application Publication
(10) Pub. No.: US 2023/0091337 A1
(43) Pub. Date: Mar. 23, 2023

(54) TONER SET

(71) Applicant: ZEON CORPORATION, Tokyo (JP)

(72) Inventor: Takeru Chiba, Tokyo (JP)

(73) Assignee: ZEON CORPORATION, Tokyo (JP)

(21) Appl. No.: 17/801,083

(22) PCT Filed: Feb. 26, 2021
(86) PCT No.: PCT/JP2021/007368

§ 371 Date: Aug. 19, 2022

(30) Foreign Application Priority Data
Feb. 28, 2020 (JP) 2020-034349

(51) Int. Cl. G03G 9/09; G03G 9/087; G03G 9/08; G03G 9/097; G03G 15/16

(52) U.S. Cl. CPC G03G 9/0906; G03G 9/08773; G03G 9/0819; G03G 9/09725; G03G 9/08711; G03G 15/161

(57) ABSTRACT

A toner set and an image forming method, both of which can print a full-color image that is superior in gradation and color reproducibility of an image including a higher-order color and superior in continuous printing durability. When one color toner selected from the group consisting of the color toners included in the toner set is defined as a first toner and other color toners are defined as second toners, an internal friction angle θ1 (°) of the first toner and an internal friction angle θ2 (°) of each of the second toners satisfy relationships represented by the following formulae (1) and (2), and a first image developed with the first toner and second images developed with the second toners are transferred in this order on a recording medium or a transfer medium to form an image including a higher-order color:

θ1<θ2 Formula (1):

1°≤θ2−θ1≤3°. Formula (2):

### TECHNICAL FIELD

The present disclosure relates to a toner set comprising a combination of various toners for developing electrostatic images (hereinafter may be simply referred to as “toners”) which are used to develop an electrostatic latent image in, for example, electrophotography, electrostatic recording, and electrostatic printing. The present disclosure also relates to an image forming method using the toner set.

### BACKGROUND ART

In image forming devices such as an electrophotographic device, an electrostatic recording device and an electrostatic printing device, a method for forming a desired image by forming an electrostatic latent image on a photoconductor and developing the image with a toner for developing electrostatic images, is widely used. This method is applied to a copying machine, a printer, a facsimile machine, multifunctional printers thereof, and so on.

For example, in an electrophotographic device using electrophotography, generally, the surface of its photoconductor comprising a photoconductive material, is uniformly charged by various kinds of methods; by changing a static charge distribution with laser beam irradiation, an electrostatic latent image having a static charge distribution which can form an image required to be reproduced or which can form a negative image corresponding to the required image, is formed on the photoconductor; the electrostatic latent image is developed with a toner to form a toner image; the toner image is transferred onto a recording medium such as print paper directly or through a transfer medium; and then the transferred toner image is fixed by heating or the like, thereby obtaining a copy.

In the case of forming a full-color image with toners for developing electrostatic images, first, an original image required to be reproduced, is separated into the three primary color components of yellow (Y), magenta (M) and cyan (C), or the four color components of the three primary colors and black (K). Then, the electrostatic latent images of each of the color components are formed on different photoconductors and developed, thereby forming the primary color toner images of each of the color components. Then, the primary color toner images of each of the color components are aligned on and transferred onto a transfer receptive medium selected from a recording medium and a transfer medium, thereby forming a higher-order color toner image including a higher-order color such as a secondary and tertiary color, which is created by overlapping the primary colors. When the higher-order color toner image is formed on a transfer medium, the image is transferred onto a recording medium. Then, the higher-order color toner image on the recording medium is fixed by heating or the like, thereby obtaining a full-color image including a higher-order color gradation area.

To provide a toner for electrostatic charge image development, which is superior in gradation when a higher-order color halftone image is formed, Patent Literature 1 discloses a toner for electrostatic charge image development, which contains toner particles having a large diameter-side volume particle size distribution index (GSDv(90/50)) of 1.26 or less and a small diameter-side volume particle size distribution index (GSDp(50/10)) of 1.28 or less, where GSDv(90/50)/GSDp(50/10) is 0.96 or more and 1.01 or less, and having an average circularity of 0.95 or more and 1.00 or less. Patent Literature 1 also discloses a toner set such that the toners included therein are toners of different colors and they are the above-mentioned toners for electrostatic charge image development, which contains the toner particles.

An experiment is described in Patent Literature 1, in which a printing test was conducted with the toner of Patent Literature 1. According to the experiment, the printing test was conducted by the following method. An original image is subjected to color separation to obtain the data of color components; based on the data of the color components, single toner images of different colors are formed; the toner images are sequentially transferred onto one transfer medium to overlap the colors on the transfer medium, thereby forming a full-color image; and then the full-color image is transferred from the transfer medium to a recording medium.

To provide a toner that offers a printout matter with high image quality and with no image problems such as fog and ghost under a low temperature and low humidity environment, even when it is used in a high-speed one-component developing printer for a long term, Patent Literature 2 discloses a toner that includes toner particles each containing a binder resin and colorant, and fine particles A which are present on the surface of the toner particles and which have the following characteristics (i), (ii) and (iii): the fine particles A are (i) fixed or adhered to the surface of the toner particle, (ii) fine particles with a charge control agent on their surface, and (iii) fine particles having a half-value width of 200 nm or less, in which the half-value width is the half value of the maximum peak in a range of 1 μm or less in a particle size distribution based on the number of the fine particles A. The toner of Patent Literature 2 has a wall surface frictional angle θ calculated from the following formula (1) of 16° or less; the toner has a force Fp between two toner particles of 2.0×10⁻⁸ N or less; the adhering ratio of the fine particles A to the surface of the toner is 50% by mass or more:

θ=τ/3.0 Formula (1):

where τ represents a shear stress obtained when a disc is rotated (π/36)rad revolutions at (π/10)rad/min, while causing the disc to enter, at a vertical load of 3.0 kPa, a toner powder layer formed by applying a vertical load of 9.0 kPa.

Patent Literature 2 mentions the results of an experiment in which a single toner image was output on paper, and the halftone image density in-plane stability, fog density and transfer efficiency of the obtained output image were evaluated. In this experiment, a printing test was conducted by use of a single toner, and a printing test in which a full-color image is formed by use of toners of several colors, was not conducted.

### CITATION LIST

### Patent Literatures

Patent Literature 1: Japanese Patent Application Laid-Open (JP-A) No. 2019-61178

Patent Literature 2: JP-A No. 2018-45004

### SUMMARY OF INVENTION

### Technical Problem

An object of the present disclosure is to provide a toner set and an image forming method, both of which can print a full-color image that is superior in gradation and color reproducibility of an image including a higher-order color and superior in continuous printing durability by developing electrostatic images.

### Solution to Problem

According to the present disclosure, a color toner set for developing electrostatic images is provided, the toner set comprising a combination of color toners each of which comprises colored resin particles containing a binder resin, a colorant and a charge control agent, and the combination including at least a yellow toner, a cyan toner and a magenta toner,

wherein, when one color toner selected from the group consisting of the color toners included in the toner set is defined as a first toner and other color toners are defined as second toners, an internal friction angle θ1 (°) of the first toner and an internal friction angle θ2 (°) of each of the second toners satisfy relationships represented by the following formulae (1) and (2):

θ1<θ2 Formula (1):

1°≤θ2−θ1≤3°. Formula (2):

In an embodiment of the present disclosure, the color toner set for developing electrostatic images is configured to be used in a full-color printer which comprises developing devices corresponding to the color toners included in the toner set and in which primary color images produced by the developing devices are sequentially transferred onto one transfer receptive medium selected from the group consisting of a recording medium and a transfer medium to form an image including a higher-order color on the transfer receptive medium;

the one color toner defined as the first toner is an initial color toner configured to be used in a developing device for producing a primary color image which is transferred first onto the transfer receptive medium; and

the other color toners defined as the second toners are other toners configured to be used in developing devices for producing primary color images which are transferred second or later onto the transfer receptive medium.

In an embodiment of the present disclosure, the first toner is the one color toner selected from the group consisting of the yellow toner, the cyan toner and the magenta toner.

In an embodiment of the present disclosure, the θ1 is 17° or more and 20° or less, and the θ2 is 20° or more and 23° or less.

In an embodiment of the present disclosure, the first toner comprises, as an external additive, silicone resin particles such that a number average particle diameter thereof is from 0.05 μm to 1.00 μm and a ratio (BS/TS) of a BET specific surface area (BS) measured by a gas adsorption method to a theoretical specific surface area (TS) obtained by a theoretical calculation formula using a number average particle diameter measured by scanning electron microscope (SEM) observation, is in a range of from 3.0 to 30.0, and

the second toners are free of the silicone resin particles.

In an embodiment of the present disclosure, the first and second toners further comprise, as an external additive, silica particles A which have a number average particle diameter of from 5 nm to 30 nm and of which surface is hydrophobized with at least one hydrophobizing agent selected from the group consisting of a hydrophobizing agent containing an amino group, a silane coupling agent and a silicone oil, and

an amount of the silica particles A contained in each of the second toners is 1.1 or more times an amount of the silica particles A contained in the first toner.

In an embodiment of the present disclosure, the first and second toners further comprise, as an external additive, silica particles B which have a number average particle diameter of from 31 nm to 200 nm and of which surface is hydrophobized with at least one hydrophobizing agent selected from the group consisting of a hydrophobizing agent containing an amino group, a silane coupling agent and a silicone oil, and an amount of the silica particles B contained in each of the second toners is 1.1 or more times an amount of the silica particles B contained in the first toner.

In an embodiment of the present disclosure, an average circularity of the colored resin particles of the first and second toners is 0.97 or more and 1.00 or less.

According to the present disclosure, an image forming method is also provided, which is a method for forming an image by an electrostatic image development type full-color printer using the color toner set for developing electrostatic images,

the method comprising:

developing a first image which is a primary color image formed with the first toner,

developing second images which are primary color images formed with the second toners,

forming an image including a higher-order color on a transfer medium by transferring the first image and then the second images onto the transfer medium,

transferring the image including the higher-order color formed on the transfer medium onto a recording medium, and

fixing the image including the higher-order color transferred onto the recording medium on the recording medium.

According to the present disclosure, another image forming method is provided, which is a method for forming an image by an electrostatic image development type full-color printer using the color toner set for developing electrostatic images,

the method comprising:

developing a first image which is a primary color image formed with the first toner,

developing second images which are primary color images formed with the second toners,

forming an image including a higher-order color on a recording medium by transferring the first image and then the second images onto the recording medium, and

fixing the image including the higher-order color transferred onto the recording medium on the recording medium.

In an embodiment of the present disclosure, paper is used as the recording medium.

### Advantageous Effects of Invention

According to the above-mentioned toner set and image forming method of the present disclosure, when a full-color image is printed by electrostatic image development, a full-color image that is superior in gradation and color reproducibility of an image including a higher-order color (such as a secondary and tertiary color) and superior in continuous printing durability, is obtained.

### BRIEF DESCRIPTION OF DRAWINGS

FIG. 1 is a schematic view of an example of the image forming device to which the image forming method of the present disclosure is applicable.

### DESCRIPTION OF EMBODIMENTS

Hereinafter, the present disclosure will be described in detail.

In the present disclosure, the term “primary color” means a color obtained by printing with a single color toner; the term “secondary color” means a color obtained by overlapping primary color toner images of two colors; and the term “higher-order color” means a color obtained by overlapping primary color toner images of several colors.

Also in the present disclosure, the term “toner image” literally means an image formed with a toner. In particular, the term is used to emphasize the following: the state that the toner is distributed according to an image required to be reproduced on an image holding surface such as a photoconductor, transfer medium or recording medium, is detected as a visual image.

Also in the present disclosure, the term “initial color” means the color of a primary color toner image which is transferred first onto a transfer receptive medium when a full-color image is formed as follows: primary color toner images of various colors are formed by use of several toner developing devices; the toner images are sequentially transferred onto one transfer receptive medium (recording medium or transfer medium) to overlap the colors on the transfer receptive medium, thereby forming a full-color image.

Also in the present disclosure, the term “initial developing device” means a developing device used to develop a primary color toner image of the initial color. When several toner developing devices are aligned in series along the conveyor path of the transfer receptive medium (recording medium or transfer medium) in a developing system, the developing device that the transfer receptive medium following the conveyor path meets first, is the “initial developing device”.

The method for forming a full-color image by electrostatic image development, is broadly classified into the following two methods based on differences in transfer steps.

(1) A full-color image forming method in which an original image is subjected to color separation to obtain the data of color components; based on the data of the color components, single toner images of several colors are formed; the toner images are sequentially transferred onto one transfer medium to overlap the colors on the transfer medium, thereby forming a full-color image; and then the full-color image is transferred from the transfer medium to a recording medium.

(2) A full-color image forming method in which an original image is subjected to color separation to obtain the data of color components; based on the data of the color components, single toner images of several colors are formed; and the toner images are sequentially transferred onto one recording medium to overlap the colors on the recording medium, thereby forming a full-color image.

It was found that in any of the above methods, the color reproducibility, color unevenness and image density unevenness of an image including a higher-order color, can be improved when the toner configured to form the primary color image that is transferred first onto the transfer receptive medium (the recording medium or transfer medium) for overlapping colors and the toners configured to form the primary color images that are transferred second or later onto the transfer receptive medium, have certain relationships in terms of internal friction angle.

The color toner set of the present disclosure is the toner set including a combination of various color toners each of which contains colored resin particles containing a binder resin and a colorant, and the combination including at least a yellow toner, a cyan toner and a magenta toner,

wherein, when one color toner selected from the group consisting of the color toners included in the toner set is defined as a first toner and other color toners are defined as second toners, an internal friction angle θ1 (°) of the first toner and an internal friction angle θ2 (°) of each of the second toners satisfy relationships represented by the following formulae (1) and (2):

θ1<θ2 Formula (1):

1°≤θ2−θ1≤3°. Formula (2):

The present disclosure also encompasses the following two image forming methods. One is the image forming method in which the colors are overlapped on the transfer medium, and the other is the image forming method in which the colors are overlapped on the recording medium.

The first method is a method for forming an image by an electrostatic image development type full-color printer using the color toner set of the present disclosure,

the method comprising:

developing a first image which is a primary color image formed with the first toner (the first image developing step),

developing second images which are primary color images formed with the second toners (the second images developing step),

forming an image including a higher-order color on a transfer medium by transferring the first image and then the second images onto the transfer medium (the step of overlapping colors on a transfer medium),

transferring the image including the higher-order color formed on the transfer medium onto a recording medium (the higher-order color image transferring step),

and

fixing the image including the higher-order color transferred onto the recording medium on the recording medium (the fixing step).

The second method is a method for forming an image by an electrostatic image development type full-color printer using the color toner set of the present disclosure,

the method comprising:

developing a first image which is a primary color image formed with the first toner (the first image developing step),

developing second images which are primary color images formed with the second toners (the second images developing step),

forming an image including a higher-order color on a recording medium by transferring the first image and then the second images onto the recording medium (the step of overlapping colors on a recording medium), and

fixing the image including the higher-order color transferred onto the recording medium on the recording medium (the fixing step).

The toner set of the present disclosure is preferably applied to the following printing method: by use of primary color toners such as yellow, cyan and magenta toners, electrostatic latent images corresponding to the primary colors are developed to form primary color toner images on developing devices, and the obtained primary color toner images are sequentially transferred onto one transfer receptive medium selected from the group consisting of a recording medium and a transfer medium to overlap the colors on the transfer receptive medium, thereby forming a full-color image.

In the case of overlapping the colors on the recording medium, the primary color toner images are sequentially transferred onto the recording medium directly or via an intermediate transfer step from the surfaces having the toner images formed thereon of the developing devices to the transfer medium, thereby forming a full-color image including a higher-order color on the recording medium.

In the case of overlapping the colors on the transfer medium, the primary color toner images are sequentially transferred onto one transfer medium directly or via an intermediate transfer step from the surfaces having the toner images formed thereon of the developing devices to the preceding other transfer medium, thereby forming a full-color image including a higher-order color on the transfer medium; and then, the full-color image on the transfer medium is transferred onto the recording medium directly or via an intermediate transfer step onto the subsequent other transfer medium.

The first toner included in the toner set of the present disclosure is the primary color toner which is transferred first onto the transfer receptive medium in the process of overlapping the colors on one transfer receptive medium selected from the group consisting of a recording medium and a transfer medium. The second toners included in the toner set are the primary color toners which are transferred second or later in the process of overlapping the colors on the transfer receptive medium.

The first toner is generally selected from the group consisting of a yellow toner, a cyan toner and a magenta toner.

The second toners are not limited to the yellow toner, the cyan toner and the magenta toner, and they may be toners of other colors. For example, a black toner may be included in the second toners. In addition to the yellow, cyan or magenta toner of the reference yellow, cyan or magenta color, another yellow, cyan or magenta toner which is different in color parameters (such as hue, color density, lightness and chroma) from the toner of the reference yellow, cyan or magenta color, may be included in the second toners.

The reason why the above-described effects are obtained by the toner set and image forming method of the present disclosure, is thought as follows.

To accurately reproduce the original image on the recording medium by electrostatic image development, it is needed to appropriately control the amounts of the toner attached onto different parts of the surface of the recording medium. To create a new image without the original image and reproduce the new image on the recording medium as designed, it is also needed to appropriately control the amounts of the toner attached onto different parts of the surface of the recording medium.

In general, as the flowability of the toner for developing electrostatic images increases, the toner can more accurately develop an electrostatic latent image on a photoconductor. Accordingly, from the viewpoint of obtaining a natural image with rich gradation, the flowability of the toner is preferably high.

However, the following problems exist in the printing method in which the original image is subjected to color separation to obtain the data of color components; based on the data of the color components, electrostatic latent images are formed and developed to form primary color toner images of several colors; the toner images are sequentially transferred onto one transfer receptive medium to overlap the colors on the transfer receptive medium, thereby forming a full-color image.

(1) At the stage after the primary color toner image of the first color is transferred onto the transfer receptive medium, a part where the toner with high flowability is already attached and a part where such a toner is not attached, exist on the transfer receptive medium. At the stage where the second and subsequent primary color toner images are transferred onto the transfer receptive medium, if the other color toners with high flowability are placed on and transferred to the part to which the toner with high flowability is already attached of the transfer receptive medium, the adhesion between the toners becomes insufficient, and it is difficult to attach the toners to target positions. Accordingly, the toner-attached positions are misaligned.

(2) In the printing method in which a full-color image is formed by using paper (recording paper) as the recording medium and overlapping colors on the recording paper, paper powder present on the recording paper is mixed into the primary color toner image of the initial color transferred onto the recording paper. Accordingly, the image quality of the primary color toner image of the initial color is likely to deteriorate. At the stage where the recording paper passes through the initial developing device, most of the power powder is removed from the recording paper. Accordingly, when the second and subsequent primary color toner images are transferred onto the recording paper, a deterioration caused by the mixing with the paper powder does not occur in the image quality of the second and subsequent primary color toner images transferred onto the recording paper.

Accordingly, it is highly necessary for the primary color toner image of the initial color transferred to the recording paper to increase its image quality compared to the second and subsequent primary color toner images.

(3) In the printing method in which a full-color image is formed by using paper (recording paper) as the recording medium and overlapping colors on the recording paper, a charge reduction caused by the mixing with the paper powder from the paper, is seen especially in the initial color. Accordingly, it interferes with an increase in continuous printing durability.

The above problems (1), (2) and (3) are solved by use of the color toner set for developing electrostatic images of the present disclosure. The color toner set is characterized in that in the printing method in which a full-color image is formed by sequentially transferring primary color images of several colors onto one transfer receptive medium (recording medium or transfer medium) and overlapping the colors on the transfer receptive medium, the internal friction angle θ1 (°) of the toner configured to form the primary color toner image which is transferred first onto the transfer receptive medium (the initial color toner) and the internal friction angle θ2 (°) of each of the toners configured to form the primary color toner images which are transferred second or later onto the same transfer receptive medium (the other toners) satisfy the relationships represented by the following formulae (1) and (2):

θ1<θ2 Formula (1):

1°≤θ2−θ1≤3°. Formula (2):

The internal friction angle of each toner serves as an index of the degree of the flowability of the toner. As the internal friction angle of each toner decreases, the flowability of the toner increases. On the other hand, as the internal friction angle of each toner increases, the flowability of the toner decreases.

When the internal friction angle θ1 (°) of the initial color toner and the internal friction angle θ2 (°) of each of the other toners satisfy the relationship represented by the formula (1), since the internal friction angle θ1 (°) of the initial color toner is small, the flowability of the initial color toner can be increased, and the image quality of the primary color image which is transferred first onto the transfer receptive medium can be superior, accordingly. At the same time, since the internal friction angle θ2 (°) of each of the other toners transferred second or later onto the transfer receptive medium is large, the flowability of the other toners can be decreased. Accordingly, when the second and subsequent toners are further transferred onto the initial color toner image transferred earlier on the transfer receptive medium, the adhesion between the preceding toner and the subsequent toners can be increased, and the subsequent toners can be attached to target positions. That is, the color overlapping properties of the toners are also enhanced.

Also, the printing durability of each toner increases as the internal friction angle of the toner decreases. In the printing method in which a full-color image is formed by using paper (recording paper) as the recording medium and overlapping colors on the recording paper, when the internal friction angle θ1 (°) of the initial color toner and the internal friction angle θ2 (°) of each of the other toners satisfy the relationship represented by the formula (1), the printing durability of the initial color toner which is affected by the paper powder, is improved. Accordingly, the printing durability of the whole toner set obtained by combining toners of several colors including the initial color toner, can be improved.

Also, when the internal friction angle θ1 (°) of the initial color toner and the internal friction angle θ2 (°) of each of the other toners satisfy the relationship represented by the formula (2), the printing durability and secondary color reproducibility of the initial color toner which is affected by the paper powder, can be balanced.

For the toner set and image forming method of the present disclosure, accordingly, in the printing method in which a full-color image is formed by sequentially transferring primary color images of several colors onto one transfer receptive medium and overlapping the colors on the transfer receptive medium, the image quality of the primary color image of the initial color is enhanced and, at the same time, the color overlapping properties of the primary color images of the other colors, which are transferred second or later, are enhanced. Accordingly, a full-color image that is superior in gradation and color reproducibility of an image including a higher-order color, is obtained.

Also for the toner set and image forming method of the present disclosure, in the printing method in which a full-color image is printed by using paper (recording paper) as the recording medium and overlapping the colors on the recording paper, the image quality of the primary color image of the initial color and the printing durability of the primary color toner of the initial color do not cause a deterioration arising from the mixing with the paper powder. Accordingly, a full-color image that is superior in gradation and color reproducibility of an image including a higher-order color and superior in continuous printing durability, is obtained.

### 1. Toner Set

The toner set of the present disclosure includes at least three color toners of a yellow toner, a cyan toner and a magenta toner. It may further include the other color toner. Each color toner contains colored resin particles containing a binder resin and a colorant, and an external additive.

Hereinafter, the method for producing colored resin particles used in the present disclosure, the colored resin particles obtained by the production method, the method for producing a toner by use of the colored resin particles, the toner obtained by the production method, and the toner set of the present disclosure which includes the toners obtained by the production method, will be described in order.

1-1. Method for Producing Colored Resin Particles

In general, methods for producing colored resin particles are broadly classified into dry methods such as a pulverization method and wet methods such as an emulsion polymerization agglomeration method, a suspension polymerization method and a solution suspension method. The wet methods are preferable since a toner having excellent printing properties such as image reproducibility, can be easily obtained. Among the wet methods, polymerization methods such as the emulsion polymerization agglomeration method and the suspension polymerization method are preferable, since a toner having a relatively small particle size distribution in micron order can be easily obtained. Among the polymerization methods, the suspension polymerization method is more preferable.

The emulsion polymerization agglomeration method is a method for producing colored resin particles by polymerizing emulsified polymerizable monomers to obtain a resin microparticle emulsion, and aggregating the resulting resin microparticles with a colorant dispersion, etc. The solution suspension method is a method for producing colored resin particles by forming a solution into droplets in an aqueous medium, the solution containing toner components (such as a binder resin and a colorant) dissolved or dispersed in an organic solvent, and removing the organic solvent. Both methods can be carried out by known methods.

The colored resin particles used in the present disclosure can be produced by the wet methods or the dry methods. The suspension polymerization method is especially preferable among the wet methods. When the suspension polymerization method is employed, the colored resin particles are produced by the following steps.

(A) Suspension Polymerization Method

(A-1) Preparation Step of Polymerizable Monomer Composition

First, a polymerizable monomer, a colorant and, as needed, another additive such as a charge control agent or the like are mixed to prepare a polymerizable monomer composition. For example, a media type dispersing machine is used for mixing them in the preparation of the polymerizable monomer composition.

In the present disclosure, the polymerizable monomer means a monomer having a polymerizable functional group, and a binder resin is made by polymerization of the polymerizable monomer. It is preferable to use a monovinyl monomer as a main component of the polymerizable monomer.

As the monovinyl monomer, examples include, but are not limited to, styrene; styrene derivatives such as vinyltoluene and α-methylstyrene; acrylic acid and methacrylic acid; acrylic acid esters such as methyl acrylate, ethyl acrylate, propyl acrylate, butyl acrylate, 2-ethylhexyl acrylate and dimethylaminoethyl acrylate; methacrylic acid esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. These monovinyl monomers may be used solely or in combination of two or more kinds. Among them, styrene, the styrene derivatives, and the acrylic or methacrylic esters are preferably used as the monovinyl monomer.

To improve hot offset and shelf stability, it is preferable to use any crosslinkable polymerizable monomer in combination with the monovinyl monomer. The crosslinkable polymerizable monomer means a monomer having two or more polymerizable functional groups.

As the crosslinkable polymerizable monomer, examples include, but are not limited to, aromatic divinyl compounds such as divinyl benzene, divinyl naphthalene and derivatives thereof; ester compounds such as ethylene glycol dimethacrylate and diethylene glycol dimethacrylate, in which two or more carboxylic acids having a carbon-carbon double bond are esterified to an alcohol having two or more hydroxyl groups; other divinyl compounds such as N,N-divinylaniline and divinyl ether; and compounds having three or more vinyl groups. These crosslinkable polymerizable monomers can be used solely or in combination of two or more kinds.

In the present disclosure, the crosslinkable polymerizable monomer is used in an amount of generally from 0.1 parts by mass to 5 parts by mass, and preferably from 0.3 parts by mass to 2 parts by mass, with respect to 100 parts by mass of the monovinyl monomer.

It is preferable to use a macromonomer as a part of the polymerizable monomer, since a good balance between the shelf stability and low-temperature fixability of the toner is obtained. The macromonomer has a polymerizable carbon-carbon unsaturated double bond at the end of the molecular chain and is a reactive oligomer or polymer which usually has a number average molecular weight of from 1,000 to 30,000. It is preferable that the macromonomer can form a polymer having a glass transition temperature (hereinafter sometimes referred as “Tg”) higher than that of a polymer obtained by polymerizing a monovinyl monomer.

It is desirable that the macromonomer is used in an amount of preferably from 0.03 parts by mass to 5 parts by mass, and more preferably from 0.05 parts by mass to 1 part by mass, with respect to 100 parts by mass of the monovinyl monomer.

As the yellow colorant used in the yellow toner, for example, a compound such as an azo pigment (e.g., monoazo or disazo pigment) and a condensed polycyclic pigment is used. As the compound, examples include, but are not limited to, C.I. Pigment Yellow 3, 12, 13, 14, 15, 17, 62, 65, 73, 74, 83, 93, 97, 120, 138, 155, 180, 181, 185, 186 and 213.

As the magenta colorant used in the magenta toner, for example, a compound such as an azo pigment (e.g., monoazo or disazo pigment) and a condensed polycyclic pigment is used. As the compound, examples include, but are not limited to, C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269, and C.I. Pigment Violet 19.

As the cyan colorant used in the cyan toner, for example, a copper phthalocyanine compound, derivatives thereof and an anthraquinone compound can be used. As the compounds, examples include, but are not limited to, C.I. Pigment Blue 2, 3, 6, 15, 15:1, 15:2, 15:3, 15:4, 16, 17:1 and 60.

As the black colorant used in the black toner, examples include, but are not limited to, carbon black, titanium black and oil black. As the carbon black, one having a primary particle diameter of from 20 nm to 40 nm is preferably used.

In the present disclosure, these colorants can be used solely or in combination of two or more kinds. The amount of the colorant is preferably from 1 part by mass to 10 parts by mass, with respect to 100 parts by mass of the binder resin or 100 parts by mass of the polymerizable (preferably monovinyl) monomer.

To improve the chargeability of the toner, a charge control agent may be used in the present disclosure. As the charge control agent, charge control agents that have been used in toners can be used without any particular limitation. Of the charge control agents, a charge control resin is preferably used due to the following reasons: the charge control resin has high compatibility with a binder resin; the charge control resin is colorless; and a toner that is stably charged during high-speed continuous color printing, can be obtained.

As a positively-chargeable charge control resin, for example, a quaternary ammonium (salt) group-containing copolymer produced in accordance with the description in JP-A No. S63-60458, H03-175456, H03-243954 or H11-15192 can be used. As a negatively-chargeable charge control resin, for example, a sulfonic acid (salt) group-containing copolymer produced in accordance with the descriptions in JP-A No. H01-217464 or H03-15858 can be used.

The amount of a monomer unit having a quaternary ammonium (salt) group or sulfonic acid (salt) group contained in the copolymers, is preferably from 0.5% by mass to 15% by mass, and more preferably from 1% by mass to 10% by mass. When the amount is in the range, it is easy to control the charge amount of the toner, and fog is less likely to occur.

The weight average molecular weight of the charge control resin is preferably from 2,000 to 50,000, more preferably from 4,000 to 40,000, and most preferably from 6,000 to 35,000. When the weight average molecular weight of the charge control resin is less than 2,000, toner offset may occur. On the other hand, when the weight average molecular weight is more than 50,000, the fixability of the toner may deteriorate.

The glass transition temperature of the charge control resin is preferably from 40° C. to 80° C., more preferably from 45° C. to 75° C., and most preferably from 45° C. to 70° C. When the glass transition temperature is less than 40° C., the shelf stability of the toner may deteriorate. When the glass transition temperature is more than 80° C., the fixability of the toner may deteriorate.

The amount of the charge control agent is generally from 0.01 parts by mass to 30 parts by mass, and preferably from 0.3 parts by mass to 25 parts by mass, with respect to 100 parts by mass of the binder resin or 100 parts by mass of the polymerizable (preferably monovinyl) monomer.

From the viewpoint of improving the releasability of the toner from a fixing roller during fixing, a release agent can be added to the polymerizable monomer composition as another additive. As the release agent, one that is generally used as a release agent for toners, can be used without particular limitation.

As the release agent, examples include, but are not limited to, polyolefin waxes such as low-molecular-weight polyethylene, low-molecular-weight polypropylene and low-molecular-weight polybutylene; natural plant waxes such as candelilla wax, carnauba wax, rice wax, Japan wax and jojoba wax; petroleum waxes such as paraffin wax, microcrystalline wax and petrolatum, and modified waxes thereof; synthetic waxes such as Fischer-Tropsch wax; ester compounds such as pentaerythritol tetramyristate, pentaerythritol tetrapalmitate, pentaerythritol tetrabehenate, behenyl behenate, and dipentaerythritol hexamyristate; and mineral waxes such as ozokerite.

The amount of the release agent is preferably from 0.1 parts by mass to 30 parts by mass, and more preferably from 1 part by mass to 20 parts by mass, with respect to 100 parts by mass of the binder resin or 100 parts by mass of the polymerizable (preferably monovinyl) monomer.

It is preferable to use a molecular weight modifier as another additive, when the polymerizable monomer is polymerized into the binder resin.

The molecular weight modifier is not particularly limited, as long as it is one that is generally used as a molecular weight modifier for toners. As the molecular weight modifier, examples include, but are not limited to, mercaptans such as t-dodecyl mercaptan, n-dodecyl mercaptan, n-octyl mercaptan and 2,2,4,6,6-pentamethylheptane-4-thiol, and thiuram disulfides such as tetramethyl thiuram disulfide, tetraethyl thiuram disulfide, tetrabutyl thiuram disulfide, N,N′-dimethyl-N,N′-diphenyl thiuram disulfide and N,N′-dioctadecyl-N,N′-diisopropyl thiuram disulfide. These molecular weight modifiers may be used solely or in combination of two or more kinds.

In the present disclosure, it is desirable that the molecular weight modifier is used in an amount of generally from 0.01 parts by mass to 10 parts by mass, and preferably from 0.1 parts by mass to 5 parts by mass, with respect to 100 parts by mass of the binder resin or 100 parts by mass of the polymerizable (preferably monovinyl) monomer.

The toner may contain a styrene-based thermoplastic elastomer as another additive. The styrene-based thermoplastic elastomer encompasses random, block and graft copolymers of styrene-based monomers with at least one monomer which is copolymerizable with the styrene-based monomers and selected from monoolefin, diolefin and the like, and hydrogenated products of the copolymers.

When the toner contains the styrene-based thermoplastic elastomer, the fixability of the toner can be improved while maintaining the heat resistant temperature of the toner.

As the styrene-based thermoplastic elastomer, examples include, but are not limited to, a styrene-butadiene-styrene-type block copolymer, a styrene-butadiene-type block copolymer, a styrene-isoprene-styrene-type block copolymer, a styrene-isoprene-type block copolymer, a styrene-butadiene-isoprene-styrene-type block copolymer and hydrogenated products thereof; a styrene-ethylene-butylene-styrene-type block copolymer, a styrene-ethylene-propylene-styrene-type block copolymer and a styrene-ethylene-ethylene-propylene-styrene-type block copolymer.

Among the styrene-based thermoplastic elastomers, from the viewpoint of optimizing the balance between the shelf stability and low temperature fixability of the toner, the styrene-isoprene-styrene-type block copolymer is preferably used.

In the styrene-based thermoplastic elastomer, the styrene content rate is preferably from 15% by mass to 70% by mass, more preferably from 15% by mass to 60% by mass, and still more preferably from 20% by mass to 40% by mass. When the styrene content rate is equal to or more than the lower limit, the hydrocarbon unit rate is not too high, and the fixed toner is less likely to be detached from the fixed surface. Accordingly, a decrease in fixability is suppressed. On the other hand, when the styrene content rate is equal to or less than the upper limit, compatibility with the binder resin is not too high, and a decrease in the shelf stability of the toner is suppressed.

The weight average molecular weight Mw of the styrene-based thermoplastic elastomer is not particularly limited. The weight average molecular weight is preferably from 50,000 to 350,000, and more preferably from 80,000 to 250,000, since it is highly effective in increasing the fixability of the toner while maintaining the heat resistant temperature of the toner.

The amount of the styrene-based thermoplastic elastomer is preferably from 0.5 parts by mass to 10 parts by mass, more preferably from 1 part by mass to 8 parts by mass, and still more preferably from 2 parts by mass to 6 parts by mass, with respect to 100 parts by mass of the binder resin or 100 parts by mass of the polymerizable monomer (preferably monovinyl monomer).

The above-listed styrene-based thermoplastic elastomers may be used solely or in combination of two or more kinds.

(A-2) Suspension Step to Obtain Suspension (Droplets Forming Step)

In the present disclosure, it is preferable that the polymerizable monomer composition containing at least the polymerizable monomer and the colorant are dispersed in an aqueous medium preferably containing a dispersion stabilizer; a polymerization initiator is added therein; and then the polymerizable monomer composition is formed into droplets. The method for forming the droplets is not particularly limited. The droplets are formed, for example, by means of a device capable of strong stirring, such as an (in-line type) emulsifying and dispersing machine (product name: MILDER; manufactured by: Pacific Machinery & Engineering Co., Ltd.) and a high-speed emulsification dispersing machine (product name: T. K. HOMOMIXER MARK II; manufactured by: PRIMIX Corporation).

As the polymerization initiator, examples include, but are not limited to, persulfates such as potassium persulfate and ammonium persulfate; azo compounds such as 4,4′-azobis(4-cyanovaleric acid), 2,2′-azobis(2-methyl-N-(2-hydroxyethyl) propionamide), 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-butylperoxy diethylacetate, t-hexylperoxy-2-ethylbutanoate, diisopropylperoxydicarbonate, di-t-butylperoxyisophthalate and t-butylperoxyisobutyrate.

They can be used solely or in combination of two or more kinds. Among them, the organic peroxides are preferably used since they can reduce a residual polymerizable monomer and can impart excellent printing durability.

Among the organic peroxides, preferred are peroxy esters, and more preferred are non-aromatic peroxy esters (i.e., peroxy esters having no aromatic ring), since they have good initiator efficiency and can reduce a residual polymerizable monomer.

The polymerization initiator may be added after dispersing the polymerizable monomer composition in the aqueous medium and before forming the droplets as described above, or it may be added to the polymerizable monomer composition before dispersing the polymerizable monomer composition in the aqueous medium.

In the present disclosure, the aqueous medium means a medium containing water as a main component. The dispersion stabilizer is preferably added to the aqueous medium. As the dispersion stabilizer, examples include the following inorganic and organic compounds: inorganic compounds including sulfates such as barium sulfate and calcium sulfate, carbonates such as barium carbonate, calcium carbonate and magnesium carbonate, phosphates such as calcium phosphate, metal oxides such as aluminum oxide and titanium oxide, and metal hydroxides such as aluminum hydroxide, magnesium hydroxide and iron(II) hydroxide, and organic compounds including water-soluble polymers such as polyvinyl alcohol, methyl cellulose and gelatin; anionic surfactants, nonionic surfactants, and ampholytic surfactants. These dispersion stabilizers can be used solely or in combination of two or more kinds.

Among the above dispersion stabilizers, the inorganic compounds are preferable, and a colloid of a hardly water-soluble metal hydroxide is particularly preferable. The use of the inorganic compounds, particularly the use of the colloid of the hardly water-soluble metal hydroxide, can narrow the particle size distribution of the colored resin particles and can reduce the amount of the dispersion stabilizer remaining after washing. Accordingly, the toner thus obtained becomes capable of reproducing clear images and obtains excellent environmental stability.

(A-3) Polymerization Step

The droplets are formed as described in the above (A-2), and the aqueous dispersion medium thus obtained is heated to start polymerization, thereby forming an aqueous dispersion of the colored resin particles.

The polymerization temperature of the polymerizable monomer composition is preferably 50° C. or more, and more preferably from 60° C. to 95° C. The polymerization reaction time is preferably from 1 hour to 20 hours, and more preferably from 2 hours to 15 hours.

The colored resin particles may be mixed with an external additive, and the mixture may be used as the toner. It is preferable to make the colored resin particles into so-called core-shell type (or “capsule type”) colored resin particles which are obtained by using the colored resin particles as the core layer and forming a shell layer, which is different from the core layer, outside the core layer. By covering the core layer, which is made of a substance having a low softening point, with a substance having a higher softening point, the core-shell type colored resin particles can take a balance of lowering the fixing temperature and prevention of aggregation during storage.

The method for producing the core-shell type colored resin particles by using the above-mentioned colored resin particles, is not particularly limited, and they can be produced by any conventional method. The in situ polymerization method and the phase separation method are preferable from the viewpoint of production efficiency.

Hereinafter, the method for producing the core-shell type colored resin particles according to the in situ polymerization method, will be described.

The core-shell type colored resin particles can be obtained by adding a polymerizable monomer for forming a shell layer (a polymerizable monomer for shell) and a polymerization initiator to the aqueous dispersion medium in which the colored resin particles are dispersed, and then polymerizing the monomer.

As the polymerizable monomer for shell, the above-mentioned polymerizable monomers can be similarly used. Among the polymerizable monomers, those that can provide a polymer having a Tg of more than 80° C., such as styrene, acrylonitrile and methyl methacrylate, are preferably used solely or in combination of two or more kinds.

As the polymerization initiator used for polymerization of the polymerizable monomer for shell, examples include, but are not limited to, water-soluble polymerization initiators including metal persulfates such as potassium persulfate and ammonium persulfate, and azo-type initiators such as 2,2′-azobis(2-methyl-N-(2-hydroxyethyl)propionamide) and 2,2′ azobis(2-methyl-N-(1,1-bis(hydroxymethyl)-2-hydroxyethyl)propionamide). These polymerization initiators can be used solely or in combination of two or more kinds. The amount of the polymerization initiator is preferably from 0.1 parts by mass to 30 parts by mass, and more preferably from 1 part by mass to 20 parts by mass, with respect to 100 parts by mass of the polymerizable monomer for shell.

The polymerization temperature of the shell layer is preferably 50° C. or more, and more preferably from 60° C. to 95° C. The polymerization reaction time is preferably from 1 hour to 20 hours, and more preferably from 2 hours to 15 hours.

(A-4) Washing, Filtering, Dehydrating and Drying Steps

It is preferable that after the polymerization, the aqueous dispersion of the colored resin particles obtained by the polymerization is subjected to operations of filtering, washing for removal of the dispersion stabilizer, dehydrating, and drying by several times as needed, according to any conventional method.

The washing step may be carried out by the following method: when the inorganic compound is used as the dispersion stabilizer, it is preferable that the dispersion stabilizer is dissolved in water and removed by adding acid or alkali to the aqueous dispersion of the colored resin particles. When the colloid of the hardly water-soluble inorganic hydroxide is used as the dispersion stabilizer, it is preferable that the pH of the aqueous dispersion of the colored resin particles is adjusted to 6.5 or less by adding acid. As the added acid, examples include inorganic acid such as sulfuric acid, hydrochloric acid and nitric acid, and organic acid such as formic acid and acetic acid. Among them, sulfuric acid is particularly preferable for its high removal efficiency and small impact on production facilities.

The dehydrating and filtering steps may be carried out by any of various known methods, without particular limitation. For example, a centrifugal filtration method, a vacuum filtration method and a pressure filtration method may be used. Also, the drying step may be carried out by any of various methods, without particular limitation.

(B) Pulverization Method

In the case of producing the colored resin particles by employing the pulverization method, the production is carried out by the following steps, for example.

First, a binder resin, a colorant and, as needed, another additive such as a charge control agent, are mixed by means of a mixer such as a ball mill, a V type mixer, FM MIXER (product name, manufactured by Nippon Coke & Engineering Co., Ltd.), a high-speed dissolver and an internal mixer.

Next, the thus-obtained mixture is kneaded while heating by means of a press kneader, a twin screw kneading machine, a roller or the like. The thus-obtained kneaded product is coarsely pulverized by means of a pulverizer such as a hammer mill, a cutter mill and a roller mill. The coarsely pulverized product is pulverized by finely pulverizing by means of a pulverizer such as a jet mill and a high-speed rotary pulverizer. Then, the finely pulverized product is classified into desired particle diameters by means of a classifier such as an air classifier and an airflow classifier, thereby obtaining colored resin particles produced by the pulverization method.

As the binder resin, the colorant, and another additive added as needed, those mentioned above in “(A) Suspension polymerization method” can be used in the pulverization method. Using the colored resin particles obtained by the pulverization method, core-shell type colored resin particles may be produced by the in situ polymerization method, etc., as with the colored resin particles obtained by the above-mentioned “(A) Suspension polymerization method”.

As the binder resin, other resins which are conventionally and broadly used in toners can be used. As the binder resin used in the pulverization method, examples include, but are not limited to, polystyrene, styrene-butyl acrylate copolymers, polyester resins and epoxy resins.

1-2. Colored Resin Particles

The colored resin particles are obtained by the above production method such as (A) Suspension polymerization method or (B) Pulverization method.

The colored resin particles constituting the toner will be described. The colored resin particles described below encompass both core-shell type colored resin particles and different types of colored resin particles.

The volume average particle diameter (Dv) of the colored resin particles is preferably from 5.8 μm to 7.5 μm, more preferably from 6.0 μm to 7.2 μm, and still more preferably from 6.2 μm to 6.8 μm. When the volume average particle diameter (Dv) is 5.8 μm or more, the toner can obtain high flowability, maintain excellent transferability, and keep high image density. When the volume average particle diameter (Dv) is 7.5 μm or less, the toner can keep high image resolution.

As for the colored resin particles, the ratio (Dv/Dn) of the volume average particle diameter (Dv) to the number average particle diameter (Dn) is preferably from 1.00 to 1.20, more preferably from 1.00 to 1.18, and still more preferably from 1.00 to 1.15. When the ratio Dv/Dn is 1.2 or less, the toner can keep high transferability, image density and resolution. The volume average particle diameter and number average particle diameter of the colored resin particles can be measured by means of a particle diameter distribution measuring device (product name: MULTISIZER; manufactured by: Beckman Coulter, Inc.), for example.

The average circularity of the colored resin particles is preferably from 0.97 to 1.00, and more preferably from 0.98 to 1.00, from the viewpoint of image reproducibility. When the average circularity of the colored resin particles is less than 0.96, a deterioration in thin line reproducibility in printing may occur.

In the present disclosure, the term “circularity” is defined as a value obtained by dividing the perimeter of a circle having the same area as the projected area of a particle image, by the perimeter of the projected image of the particle.

Also in the present disclosure, the term “average circularity” is used as a simple method for quantitatively representing the shape of the particles and is the index of the degree of the surface roughness of the colored resin particles. The average circularity is 1 when the colored resin particles are perfectly spherical, and it gets smaller as the surface shape of the colored resin particles becomes more complex.

The average circularity (Ca) is a value obtained by the following average circularity calculation formula:

$$Average circularity calculation formula$$

$$Average circularity ( Ca ) = ( {\sum }_{i = 1}^{n} ( Ci \times fi ) ) / {\sum }_{i = 1}^{n} ( fi )$$

In the above formula, n is the number of particles for each of which the circularity Ci is obtained.

In the above formula, Ci is the circularity of each of particles having an equivalent circle diameter of from 0.6 μm to 400 μm and is calculated by the following circularity calculation formula based on the perimeter measured for each particle:

Circularity (Ci)=(Perimeter of a circle having the same area as the projected area of a particle image)/(Perimeter of the projected particle image) Circularity calculation formula

In the above formula, “fi” is the frequency of the particles having the circularity Ci.

The circularity and the average circularity can be measured by means of flow particle image analyzer “FPIA-3000” (product name, manufactured by: Sysmex Corporation).

### 1-3. External Additive

By mixing and stirring the above-mentioned colored resin particles with an external additive, the external additive may be uniformly added (external addition) on the surface of the colored resin particles. The external additive is added on the surface of the colored resin particles to make a one-component toner (a developer). The one-component toner may be further mixed and stirred with carrier particles to make a two-component toner.

A mixer used for external addition is not particularly limited, as long as it is a mixer capable of adding the external additive on the surface of the colored resin particles. For example, the external addition can be carried out by means of a mixer capable of mixing and stirring, such as HENSCHEL MIXER (: product name, manufactured by Mitsui Mining Co., Ltd.), FM MIXER (: product name, manufactured by NIPPON COKE & ENGINEERING CO., LTD.), SUPER MIXER (: product name, manufactured by KAWATA Manufacturing Co., Ltd.), Q MIXER (: product name, manufactured by NIPPON COKE & ENGINEERING CO., LTD.), MECHANOFUSION SYSTEM (: product name, manufactured by Hosokawa Micron Corporation) and MECHANOMILL (: product name, manufactured by Okada Seiko Co., Ltd.)

As the external additive, particles made of an appropriate material and having an appropriate particle diameter may be selected from various kinds of inorganic fine particles and resin particles and used.

The number average particle diameter of the external additive can be measured by a conventionally known method. For example, it can be measured as follows.

First, the particle diameters of the particles of the external additive are measured by means of a transmission electron Microscope (TEM), a scanning electron microscope (SEM) or the like. For each external additive, the particle diameters of at least 30 particles are measured in this manner, and the average is determined as the number average particle diameter of the particles. When it is found by TEM or SEM observation, that the form of the particles is a non-spherical form and the particles have long and short diameters, first, the long and short diameters are measured for each external additive. As just described, for each external additive particle, the long and short diameters of at least 30 particles are measured, and the averages are determined as the average long and short diameters of the external additive. The total value of the calculated average long and short diameters is divided by 2, and the value thus obtained is determined as the number average particle diameter of the external additive.

### <Silicone Resin Particles>

In the present disclosure, to control the internal friction angle θ1 (°) of the first toner and the internal friction angle θ2(°) of each of the second toners such that they satisfy the relationships represented by the above-mentioned formulae (1) and (2), it is preferable that the first toner contains, as an external additive, silicone resin particles such that a number average particle diameter thereof is from 0.05 μm to 1.00 μm and a ratio (BS/TS) of a BET specific surface area (BS) measured by a gas adsorption method to a theoretical specific surface area (TS) obtained by a theoretical calculation formula using a number average particle diameter measured by scanning electron microscope (SEM) observation, is in a range of from 3.0 to 30.0, and the second toners are free of the silicone resin particles.

When the ratio (BS/TS) of the BET specific surface area (BS) to the theoretical specific surface area (TS) is within the above range, the particles are light and soft particles. Accordingly, collapse of the silicone resin particles can be suppressed during continuous printing. For the silicone resin particles contained in the first toner, the ratio (BS/TS) of the BET specific surface area (BS) to the theoretical specific surface area (TS) is preferably from 3.5 to 25.0, and more preferably from 4.0 to 20.0.

When the number average particle diameter of the silicone resin particles is within the above range, the toner can possess appropriate charging properties in a wide range of temperature environments and humidity environments. The number average particle diameter of the silicone resin particles is preferably from 0.07 μm to 0.50 μm, and more preferably from 0.08 μm to 0.30 μm.

The ratio (BS/TS) of the BET specific surface area (BS) to the theoretical specific surface area (TS) is used as the index of the porosity of the silicone resin particles. By the theoretical specific surface area (TS), the surface roughness of the particles cannot be evaluated; however, the surface roughness can be evaluated by the BET specific surface area (BS). Therefore, when the BS/TS ratio is high, the particles can be evaluated as particles having a high porosity. On the other hand, when the BS/TS ratio gets closer to 1, the particles can be evaluated as particles having a small porosity.

The number average particle diameter of the silicone resin particles is measured by scanning electron microscope (SEM) observation. From the number average particle diameter of the silicone resin particles, the theoretical specific surface area (TS) per unit mass of the silicone resin particles is calculated by the theoretical calculation formula.

That is, in the present disclosure, assuming that the silicone resin particles are in a spherical form (irrespective of the actual form), the theoretical specific surface area (TS) per unit mass is obtained by the following theoretical calculation formula (1) that is used to obtain the specific surface area per unit mass of a sphere.

Theoretical specific surface area TS (m²/g)=6/(Average density (g/cm³)×Number average particle diameter (nm)×103) Theoretical calculation formula (1)

The method for obtaining the average density used in the above formula is not particularly limited, and a conventionally known method can be used.

The BET specific surface area (BS) (m²/g) per unit mass measured by the gas adsorption method, can be obtained by a method for measuring the amount of a monolayer of nitrogen gas adsorbed on the silicone resin particle surface with the use of the formula of BET.

To measure the BET specific surface area (BS) of the silicone resin particles, a conventionally known method can be used. For example, the BET specific surface area (BS) of the silicone resin particles can be measured by a nitrogen adsorption method (a BET method) using a BET specific surface area measuring device (product name: MACSORB HM MODEL-1208, manufactured by: Mountech Co., Ltd.)

The water adsorption amount of the silicone resin particles is preferably 1.0% by mass or less, and more preferably 0.35% by mass or less. When the water adsorption amount of the silicone resin particles is more than 1.0% by mass, fog may be caused by a decrease in charge amount at high temperature and high humidity.

The silicone resin particles are preferably surface-hydrophobized with a hydrophobizing agent such as a silane coupling agent. The type of the hydrophobizing agent is not particularly limited. For example, the hydrophobizing agent used in the below-described silica particles A and B can be used.

The form of the silicone resin particles is not particularly limited and may be an irregular form. The form is preferably a spherical form.

The sphericity (Sc/Sr) of the silicone resin particles is preferably from 0.970 to 1.000, and more preferably from 0.985 to 1.000.

When the sphericity (Sc/Sr) of the silicone resin particles is out of the range, the toner thus obtained may be poor in thin line reproducibility.

In the present disclosure, the sphericity is defined as a value obtained by dividing the area (Sc) of a circle having the absolute maximum length of the particle as its diameter, by the substantial projected area (Sr) of the particle.

The sphericity (Sc/Sr) of the silicone resin particles is a value obtained as follows: a photograph of the silicone resin particles taken by an electron microscope, is analyzed for Sc and Sr by an image analyzer; the sphericity (Sc/Sr) of each particle is calculated; and the thus-obtained sphericities of the particles are averaged, thereby obtaining the sphericity (Sc/Sr) of the silicone resin particles.

To measure the sphericity, a conventionally known method can be used. For example, an electron micrograph of the silicone resin particles is taken, and the electron micrograph is measured by an image analyzer (product name: LUZEX IID, manufactured by: Nireco Corporation), thereby measuring the sphericity of the silicone resin particles.

### <Silica Particles A>

Also in the present disclosure, it is preferable that in addition to the silicone resin particles, the first and second toners further contain, as an external additive, silica particles A which have a number average particle diameter of from 5 nm to 30 nm and of which surface is hydrophobized with at least one hydrophobizing agent selected from the group consisting of a hydrophobizing agent containing an amino group, a silane coupling agent and a silicone oil, and the amount of the silica particles A contained in each of the second toners is 1.1 or more times the amount of the silica particles A contained in the first toner. It is also preferable that the amount of the silica particles A contained in each of the second toners is 2.0 or less times the amount of the silica particles A contained in the first toner.

Since the silica particles A having a number average particle diameter in the above range are used, a toner with superior flowability and transferability is obtained. The number average particle diameter of the silica particles A is more preferably from 7 nm to 25 nm, and still more preferably from 8 nm to 20 nm.

When the amount of the silica particles A contained in each of the second toners is within the above range, the internal friction angles can be controlled within the desired range. The amount of the silica particles A contained in each of the second toners is more preferably 1.15 or more times, and still more preferably 1.20 or more times the amount of the silica particles A contained in the first toner. Also, the amount of the silica particles A contained in each of the second toners is more preferably 1.80 or less times the amount of the silica particles A contained in the first toner.

The amount of the silica particles A contained in the first toner is preferably from 0.1 parts by mass to 2.0 parts by mass, and more preferably from 0.3 parts by mass to 1.2 parts by mass, with respect to 100 parts by mass of the colored resin particles. Then, the amount of the silica particles A contained in each of the second toners is 1.1 or more times the amount of the silica particles A contained in the first toner.

When the amount of the silica particles A contained in each of the first toner and the second toners is below the range, the toner flowability decreases, and fog and transfer failure are likely to occur. On the other hand, when the amount of the silica particles A contained therein is above the range, print soiling and fixing failure are likely to occur, which are caused by an increase in charge amount under a low temperature and low humidity environment.

The surface of the silica particles A is hydrophobized with at least one hydrophobizing agent selected from the group consisting of a hydrophobizing agent containing an amino group, a silane coupling agent and a silicone oil. In the present disclosure, a term such as being surface-hydrophobized with hydrophobizing agent, is used to show the state of the surface and to specify such a property that the surface of the silica particles is hydrophobic.

As the hydrophobizing agent containing an amino group, examples include a silicon compound containing an amino group.

The silicon compound containing an amino group is not limited to a particular compound, and various kinds of compounds can be used, such as an amino group-containing silane coupling agent, an amino-modified silicone oil, a quaternary ammonium salt type silane, and a cyclic silazane represented by the following chemical formula (1). Of them, the amino group-containing silane coupling agent and the cyclic silazane represented by the following chemical formula (1) are particularly preferred from the viewpoint of positively charging ability and flowability. As the amino group-containing silane coupling agent, examples include, but are not limited to, N-2(aminoethyl)3-aminopropylmethyldimethoxysilane, N-2(aminoethyl)3-aminopropyltrimethoxysilane, 3-aminopropyltrimethoxysilane, 3-aminopropyltriethoxysilane, and N-phenyl-3-aminopropyltriethoxysilane. Of such coupling agents, the coupling agents containing an aminoalkyl group are preferred from the viewpoint of excellent effects of enhancing the environmental stability of charging performance.

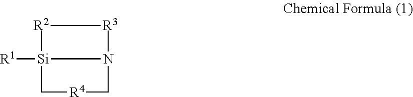

In the chemical formula (1), R¹ and R² are independently selected from the group consisting of hydrogen, halogen, alkyl, alkoxy and aryloxy; R³ is selected from the group consisting of hydrogen, —(CH₂)ₙCH₃, —C(O)(CH₂)ₙCH₃, —C(O)NH₂, —C(O)NH(CH₂)ₙCH₃ and —C(O)N[(CH₂)ₙCH₃](CH₂)ₘCH₃ (where n and m are each an integer of from 0 to 3); and R⁴ is represented by [(CH₂)ₐ(CHX)_{b}(CHY)_{c}](where X and Y are independently selected from the group consisting of hydrogen, halogen, alkyl, alkoxy and aryloxy, and a, b and c are each an integer of from 0 to 6 which satisfies such a condition that the sum of a, b and c (a+b+c) is equal to an integer of from 2 to 6).

As the silane coupling agent (except one containing an amino group), examples include, but are not limited to, disilazanes such as hexamethyldisilazane, and alkylsilane compounds such as trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane, and vinyltriacetoxysilane. These silane coupling agents may be used solely or in combination of two or more kinds. Of the silane coupling agents, hexamethyldisilazane (HMDS) is preferred.

As the silicone oil (except one containing an amino group), examples include, but are not limited to, dimethylpolysiloxane, methylhydrogenpolysiloxane, methylphenylpolysiloxane, and modified silicone oil.

As described above, for the hydrophobized silica particles surface-hydrophobized with the hydrophobizing agent, the hydrophobicity measured by a methanol method is generally from 30% to 98%, preferably from 50% to 95%, and more preferably from 60% to 90%. When the hydrophobicity is smaller than 30%, the toner is susceptible to the environment. Especially, a decrease in charge occurs at high temperature and high humidity and may easily cause fog. On the other hand, when the hydrophobicity is larger than 98%, an increase in charge occurs at low temperature and low humidity and may cause a decrease in image density.

### <Silica Particles B>

Also in the present disclosure, it is preferable that in addition to the silicone resin particles and the silica particles A, the first and second toners further contain, as an external additive, silica particles B which have a number average particle diameter of from 31 nm to 200 nm and of which surface is hydrophobized with at least one hydrophobizing agent selected from the group consisting of a hydrophobizing agent containing an amino group, a silane coupling agent and a silicone oil, and the amount of the silica particles B contained in each of the second toners is 1.1 or more times the amount of the silica particles B contained in the first toner. It is also preferable that the amount of the silica particles B contained in each of the second toners is 2.0 or less times the amount of the silica particles B contained in the first toner.

Since the silica particles B having a number average particle diameter in the above range are used, the toner flowability further increases; fog and print soiling can be suppressed; and cleaning properties can be improved.

The number average particle diameter of the silica particles B is more preferably from 35 nm to 150 nm, and still more preferably from 45 nm to 100 nm.

When the amount of the silica particles B contained in each of the second toners is within the above range, the internal friction angles can be controlled within the desired range. The amount of the silica particles B contained in each of the second toners is more preferably 1.15 or more times, and still more preferably 1.20 or more times the amount of the silica particles B contained in the first toner. Also, the amount of the silica particles B contained in each of the second toners is more preferably 1.80 or less times the amount of the silica particles B contained in the first toner.

The amount of the silica particles B contained in the first toner is preferably from 0.1 parts by mass to 3.0 parts by mass, and more preferably from 0.3 parts by mass to 2.0 parts by mass, with respect to 100 parts by mass of the colored resin particles. The amount of the silica particles B contained in each of the second toners is 1.1 or more times the amount of the silica particles B contained in the first toner.

When the amount of the silica particles B contained in each of the first toner and the second toners is below the range, a decrease in cleaning properties is likely to occur. On the other hand, when the amount of the silica particles B is above the range, print soiling and fixing failure are likely to occur at low temperature and low humidity.

The silica particles B are silica particles surface-hydrophobized with the same hydrophobizing agent as the above-mentioned silica particles A. The hydrophobizing agent used for surface hydrophobization of the silica particles A may be the same type as or a different type from the hydrophobizing agent used for surface hydrophobization of the silica particles B. The hydrophobizing agent that is preferably used for surface treatment of the silica particles B, is the same as the case of the silica particles A.

The hydrophobicity of the hydrophobized silica particles B is generally from 10% to 95%, preferably from 20% to 90%, and more preferably from 30% to 85%. When the hydrophobicity is smaller than 10%, the toner is susceptible to the environment. Especially, a decrease in charge occurs at high temperature and high humidity and may easily cause fog. On the other hand, when the hydrophobicity is larger than 95%, an increase in charge occurs at low temperature and low humidity and may cause a decrease in image density.

In the present disclosure, in addition to the silicone resin particles, the silica particles A and the silica particles B, an external additive that has been conventionally used in toners may be further contained. As such an external additive, examples include inorganic fine particles and organic fine particles. As the inorganic fine particles, examples include, but are not limited to, aluminum oxide, titanium oxide, zinc oxide, tin oxide, cerium oxide, silicon nitride, calcium carbonate, calcium phosphate, barium titanate, and strontium titanate. As the organic fine particles, examples include, but are not limited to, methacrylic acid ester polymer particles, acrylic acid ester polymer particles, styrene-methacrylic acid ester copolymer particles, styrene-acrylic acid ester copolymer particles, core-shell type particles in which the core is formed with a styrene polymer and the shell is formed with a methacrylic acid ester polymer, and melamine resin particles.

### 1-4. Internal Friction Angle of Each Toner

In the present disclosure, the internal friction angle θ1 (°) of the first toner which is transferred first onto the transfer receptive medium and the internal friction angle θ2 (°) of each of the second toners which are transferred second or later onto the transfer receptive medium, satisfy the relationships represented by the following formulae (1) and (2):

θ1<θ2 Formula (1):

1°≤θ2−θ1≤3° Formula (2):

Since the internal friction angle θ1 (°) of the first toner and the internal friction angle θ2 (°) of each of the second toners satisfy the relationship represented by the formula (1), when a full-color image is printed by electrostatic image development, the gradation and color reproducibility of a higher-order color image such as a secondary color image and a tertiary color image can be enhanced.

When the internal friction angle θ1 (°) of the first toner is equal to or larger than the internal friction angle θ2 (°) of each of the second toners, that is, when the relationship represented by the formula (1) is not satisfied, the printing durability of the initial color may decrease.

When the gap between the internal friction angle θ1 (°) of the first toner and the internal friction angle θ2 (°) of each of the second toners is too small, that is, when the difference represented by “θ2−θ1” is smaller than the lower limit of the formula (2), the color overlapping properties may be reduced.

When the gap between the internal friction angle θ1 (°) of the first toner and the internal friction angle θ2 (°) of each of the second toners is too large, that is, when the difference represented by “θ2−θ1” is larger than the upper limit of the formula (2), the colors are successfully overlapped; however, there is a large difference between the flowability of the particles of the first toner and that of the particles of the second toners. Accordingly, there is a possibility that within the range of the condition setting of the printer side, the number of sheets printed with the initial color toner and the other color toners until the appearance of a printing failure, cannot be controlled in an appropriate range.

From the viewpoint of balance between the color overlapping properties and the printing durability, as long as the relationships represented by the formulae (1) and (2) are satisfied, the internal friction angle θ1 (°) of the first toner is preferably 17° or more and 20° or less, and the internal friction angle θ2 (°) of each of the second toners is preferably 20° or more and 23° or less.

When the internal friction angle θ1 (°) of the first toner is less than 17, the flowability may be too high. Accordingly, the amount of the toner supplied onto a developing roller may decrease, and it may be a cause of blur.

When the internal friction angle θ1 (°) of the first toner is more than 20°, the printing durability may decrease.

When the internal friction angle θ2 (°) of each of the second toners is less than 20°, the flowability may be too high. Accordingly, the amount of the toner supplied onto a developing roller may decrease, and it may be a cause of blur.

When the internal friction angle θ2 (°) of each of the second toners is more than 23°, the printing durability may decrease.

### <Internal Friction Angle Measuring Method>

The internal friction angle of each toner can be obtained by shear stress measurement that is carried out by the following process using a powder flowability analyzing device (product name: FT4 POWDER RHEOMETER, manufactured by Freeman Technology, Ltd.). The powder rheometer is a flowability measuring device for directly obtaining flowability by measuring a rotation torque and a vertical load, which are obtained by spiral rotation of a rotor in filled particles, at the same time. By measuring both the rotation torque and the load, the flowability including the properties of a powder itself and the influence of the external environment can be detected with high sensitivity.

A 50 mm×85 mm vessel, which is an accessory component of the powder rheometer, is installed in the powder rheometer, and 15 g of the toner is uniformly introduced into the vessel by use of a sieve. Then, the measurement is carried out by use of blades for 48 mm shear stress measurement, which are dedicated for the device.

Shear loads at vertical loads of 1 kPa, 2 kPa, 4 kPa, 10 kPa, 15 kPa and 20 kPa are measured.

By using the measured values and by having vertical load on the horizontal axis and shear load on the vertical axis, an approximate straight line passing through the origin (X.Y=0.0) is obtained. The angle between the horizontal axis and the approximate straight line is defined as the internal friction angle of the measured toner.

### <Internal Friction Angle Controlling Method>

The internal friction angle of each of the first and second toners can be controlled by any of the methods described below or by a combination of the methods.

As the first method, the internal friction angle can be controlled by the amount of the silica particles A or B. For the internal friction angle increasing effect which is exerted by increasing the amount of the added silica particles, a larger increase in the internal friction angle is obtained by increasing the amount of the silica particles A. However, in the case of increasing only the amount of the silica particles A, the amount of silica covering the toner surface is increased. In addition, since the particle diameter of the silica particles A is smaller than that of the silica particles B, fog is likely to occur in continuous printing. Considering the overall balance, it is preferable that the silica particles A and the silica particles B are mixed at a certain content ratio and are increased and decreased at the same rate.

As another method, the internal friction angle can be controlled to be lower by increasing the amount of the added silicone resin particles. However, since the particle diameter of the silicone resin particles is larger than that of the silica particles A and that of the silica particles B, detachment of the silicone resin particles is likely to occur. Also, vertical streaks may be easily caused by increasing the amount of the added silicone resin particles.

### 2. Image Forming Method

The toner set of the present disclosure is preferably applied to the following printing method: by use of primary color toners such as yellow, cyan and magenta toners, electrostatic latent images corresponding to the primary colors are developed to form primary color toner images on developing devices, and the obtained primary color toner images are sequentially transferred from the surfaces having the toner images formed thereon of the developing devices onto one transfer receptive medium selected from the group consisting of a recording medium and a transfer medium to overlap the colors on the transfer receptive medium, thereby forming a full-color image. As the transfer medium used to overlap the colors thereon, examples include, but are not limited to, an intermediate transfer belt and an intermediate transfer roller.

As the recording medium, examples include, but are not limited to, a coated paper, an art paper, an OHP sheet, and a recording paper such as a plain paper. Especially when an image is formed on a recording paper such as a plain paper, which has a relatively large amount of paper powder thereon, the toner set of the present disclosure is highly effective in enhancing the gradation and color reproducibility of an image including a higher-order color.

As the printing device that can execute the above-mentioned process, the following full-color printer may be used, for example: a full-color printer in which developing devices corresponding to the color toners included in the toner set are aligned in series, and primary color images produced by the developing devices (color separation images) are sequentially transferred from the developing devices onto one recording medium directly or via a transfer medium to form an image including a secondary or higher-order color on the recording medium. This is a type of so-called tandem printer.

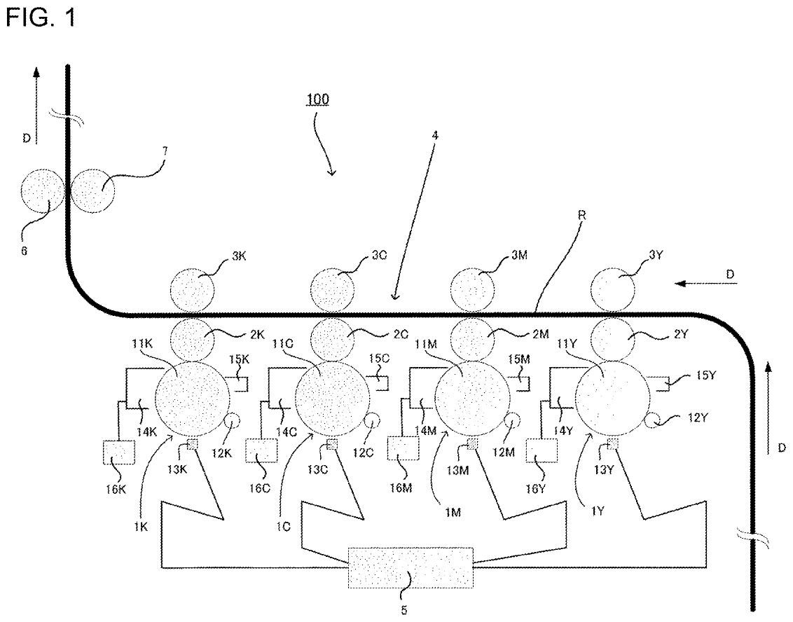

FIG. 1 is a schematic view of an example of the image forming device to which the toner set of the present disclosure is applicable. The image forming method of the present disclosure is not limited to the one shown in FIG. 1. The structure, size and form of the materials used in the method of the present disclosure are not limited to those of the materials shown in FIG. 1.

An image forming device 100 shown in FIG. 1 is a tandem printer. The image forming device 100 includes the following components: a conveyor path 4 for conveying a recording medium R; four developing devices 1Y, 1M, 1C and 1K corresponding to the four colors of yellow (Y), magenta (M), cyan (C) and black (K), respectively; transfer mediums 2Y, 2M, 2C and 2K and support rollers 3Y, 3M, 3C and 3K corresponding to the four developing devices 1Y, 1M, 1C and 1K, respectively; an exposure device 5 for applying laser light according to primary color image data obtained by color separation of the original image; and a fixing roller 6 and a support roller 7, which are paired with each other. The four developing devices 1Y, 1M, 1C and 1K corresponding to the four colors of yellow (Y), magenta (M), cyan (C) and black (K), respectively, are aligned in series along the conveying direction D of the recording medium R in the image forming device. The four developing devices are aligned in the following order from the upstream side of the conveying direction: the yellow developing device 1Y, the magenta developing device 1M, the cyan developing device 1C, and the black developing device 1K.

The structure of the developing devices will be described with reference to the yellow developing device 1Y. The developing device 1Y includes a photoconductor 11Y in a drum form, and the following components are disposed around the photoconductor 11Y: a charging roller 12Y for charging the photoconductor surface to a predetermined voltage; a laser light irradiator 13Y for irradiating the photoconductor 11Y with the laser light produced in the exposure device to form an electrostatic image; a developing section 14Y for developing the electrostatic image by supplying a charged toner to the electrostatic image; the transfer medium 2Y in a roller form for transferring the developed toner image; and a cleaner 15Y for removal of the toner remaining on the photoconductor 11Y after the toner image is transferred onto the transfer medium. The developing section 14Y is connected to a toner storage 16Y through a yellow toner supply path.

As with the yellow developing device 1Y, the remaining developing devices of other colors include a photoconductor (11M, 11C, 11K), a charging roller (12M, 12C, 12K), a laser light irradiator (13M, 13C, 13K), a developing section (14M, 14C, 14K), a cleaner (15M, 15C, 15K) and a toner storage (16M, 16C, 16K). These components and a transfer medium (2M, 2C, 2K) are disposed around the photoconductor.

The method for forming an image by use of the image forming device 100 will be described. In this device, the yellow toner is selected as the first toner having the internal friction angle 81 and used in the initial developing device 1Y. The magenta (M), cyan (C) and black (K) toners are used in the second and subsequent developing devices as the second toners having the internal friction angle θ2.

First, in the yellow developing device 1Y, the surface of the photoconductor 11Y is uniformly charged by the charging roller 12Y. A photoconductor generally has high resistance (the resistance of general resin); however, it is characterized in that once irradiated with laser light, the specific resistance of a laser-irradiated part is changed. Accordingly, laser light is produced by the exposure device 5 according to the primary color image data of yellow, and the surface of the charged photoconductor 1Y is irradiated with the laser light by the laser light irradiator 13Y. A photosensitive layer on the surface of the photoconductor 11Y is irradiated with the laser light, thereby forming an electrostatic latent image corresponding to the primary color image of yellow on the surface of the photoconductor 11Y.

The electrostatic latent image is formed by the charge left in a part not irradiated with the laser light. Accordingly, it is a negative latent image.

The electrostatic latent image on the photoconductor 11Y is moved to the position of the developing section 14Y by the rotation of the photoconductor, and the electrostatic latent image is developed there to obtain a primary color toner image of yellow.

The primary color toner image of yellow on the photoconductor is moved to the primary transfer position by the rotation of the photoconductor. At the primary transfer position, the surface of the photoconductor 11Y and the surface of the transfer medium 2Y are brought into contact with each other. Accordingly, the primary color toner image of yellow on the photoconductor undergoes primary transfer to the surface of the transfer medium 2Y.

By the rotation of the transfer medium, the primary color toner image of yellow on the transfer medium 2Y is moved to the position where the primary color toner image of yellow undergoes secondary transfer. At the secondary transfer position, the recording medium R on the conveyor path 4 is sandwiched between the transfer medium 2Y and the support roller 3Y, and the surface of the transfer medium 2Y and the image receptive surface of the recording medium R are brought into contact with each other. Accordingly, the primary color toner image of yellow on the transfer medium 2Y undergoes secondary transfer onto the recording medium R.

Next, in the magenta developing device 1M, the same process as the process of forming the primary color toner image of yellow is executed. That is, in the magenta developing device 1M, a primary color toner image of magenta is formed on the surface of the photoconductor 11M; the formed image undergoes primary transfer to the surface of the transfer medium 2M; and then the transferred image is moved to the position where the primary color toner image of magenta undergoes secondary transfer by the rotation of the transfer medium 2M. Meanwhile, a part having the primary color toner image of yellow formed thereon of the recording medium R is moved from the upstream side of the conveyor path 4 and reaches the position where the primary color toner image of magenta undergoes secondary transfer. The primary color toner image of magenta on the transfer medium 2M is aligned there with the primary color toner image of yellow on the recording medium R and undergoes secondary transfer onto the recording medium R.

Next, in the cyan developing device 1C and the black developing device 1K, the same process as the process of forming the primary color toner image of yellow is executed. Then, the primary color toner images of yellow (Y), magenta (M), cyan (C) and black (K) are overlapped in this order on the recording medium R moved by the conveyor path, thereby obtaining a full-color image including a higher-order color. The recording medium R passes through all of the developing devices, and after the image including the higher-order color is formed, the recording medium R moves to the position where the fixing step is carried out. At that position, the recording medium R is sandwiched between the fixing roller 6 and the support roller 7. Accordingly, the image including the higher-order color is fixed on the recording medium.

### EXAMPLES

Hereinafter, the present disclosure will be described further in detail, with reference to examples and comparative examples. However, the present disclosure is not limited to these examples. Herein, part(s) and % are on a mass basis unless otherwise noted.

### 1. Preparation of External Additives

### 1-1. Production of Silicone Resin Particles 1

First, 60.0 g of water and 0.01 g of acetic acid used as a catalyst, were put in a 200 mL recovery flask and stirred at 30° C. Next, 70.0 g of methyltrimethoxysilane was added thereto, and they were stirred for one hour, thereby obtaining a raw material solution.

Next, 3.0 g of a 25% ammonia aqueous solution, 128.0 g of water and 390.0 g of methanol were put in a 1000 mL recovery flask and stirred at 30° C. to prepare an alkaline aqueous medium. To the alkaline aqueous medium, the raw material solution was added in a dropwise manner for one minute. After the addition of the raw material solution, a mixed solution thus obtained was stirred as it is for 25 hours to initiate a polycondensation reaction of a fine particle precursor, thereby obtaining a polycondensation reaction solution.

As an aqueous solution, 3000 g of water was put in a 5000 mL recovery flask. With stirring the water at 25° C., the polycondensation reaction solution was added thereto in a dropwise manner for one minute. As soon as the polycondensation reaction solution was mixed with the water, it turned turbid white. As a result, a dispersion containing silicone particles was obtained.

To the dispersion of the silicone particles, 30.5 g of hexamethyldisilazane was added as a hydrophobizing agent. As a result of mixing them at 25° C. for 48 hours, a powder of hydrophobized spherical polymethylsilsesquioxane fine particles floated to the upper part of the resulting solution. The thus-obtained solution containing the floating powder was left to stand for 5 minutes to allow the powder to float on the solution surface, and the powder was recovered by suction filtration. The recovered powder was dried under reduced pressure at 100° C. for 24 hours, thereby obtaining 32 g of a dried powder of the silicone resin particles 1.

The properties of the silicone resin particles 1 are shown in Table 1.

### 1-2. Silica Particles A1

As the silica particles A1, silica particles obtained by hydrophobizing the surface of positively-chargeable silica particles (product name: TG7120, manufactured by Cabot Corporation) having a number average particle diameter of 20 nm with hydrophobizing agents (hexamethyldisilazane (HDMS) and cyclic silazane) were used.

The properties of the silica particles A1 are shown in Table 1.

### 1-3. Silica Particles B1

As the silica particles B1, silica particles obtained by hydrophobizing the surface of positively-chargeable silica particles (product name: H05TA, manufactured by Clariant Corporation) having a number average particle diameter of 50 nm with a hydrophobizing agent (aminosilane) were used.

The properties of the silica particles B1 are shown in Table 1.

TABLE 1

| | | |
|---|---|---|
| Silicone resin particles | Particles No. | Particles 1 |
| | Number average particle | 0.09 |
| | diameter Dn (μm) | |
| | Theoretical specific | 50 |
| | surface area TS (m²/g) | |
| | BET specific surface | 230 |
| | area BS (m²/g) | |
| | Ratio (BS/TS) | 4.6 |
| | Dv90/Dv50 | 2.2 |
| | Form | Spherical |
| | Sphericity (Sc/Sr) | 0.988 |
| | Water adsorption | 0.35 |
| | amount (%) | |
| Silica particles A | Particles No. | Particles A1 |
| | Hydrophobizing agent | HDMS, |
| | | Cyclic silazane |
| | Number average particle | 20 |
| | diameter Dn (nm) | |
| Silica particles B | Particles No. | Particles B1 |
| | Hydrophobizing agent | Aminosilane |
| | Number average particle | 50 |
| | diameter Dn (nm) | |

### 2. Production of Toner Set

For each color, toners different in internal friction angle were produced by the following process.

### 2-1. Yellow Toner

### (1) Production Example Y1

First, 70 parts of styrene, 30 parts of n-butyl acrylate, 0.1 parts of a polymethacrylic acid ester macromonomer (product name: AA6; manufactured by: TOAGOSEI Co., Ltd.; Tg: 94° C.) and 0.72 parts of divinylbenzene as polymerizable monomers, 1.25 parts of tetraethylthiuram disulfide as a molecular weight modifier, and 8 parts of C.I. Pigment Yellow 155 (product name: TONER YELLOW 3GP CT, manufactured by: Clariant Corporation) as a colorant, were wet-pulverized by means of a media-type disperser (product name: PICOMILL, manufactured by: ASADA IRON WORKS. Co., Ltd.)

To the mixture obtained by the wet pulverization, 0.5 parts of a charge control resin (a quaternary ammonium salt-containing styrene-acrylic resin, functional group amount: 8% by mass) and 6.0 parts of a synthetic ester wax (pentaerythritol tetrabehenate, melting point: 76° C.) were added, mixed and dissolved to prepare a polymerizable monomer composition for core.

Also, an aqueous solution in which 7.3 parts of sodium hydroxide was dissolved in 50 parts of ion exchanged water, was gradually added under stirring to an aqueous solution in which 10.4 parts of magnesium chloride was dissolved in 280 parts of ion exchanged water, whereby a magnesium hydroxide colloidal dispersion was prepared.

Also, an aqueous dispersion of a polymerizable monomer for shell was prepared by finely dispersing 2 parts of methyl methacrylate and 130 parts of water by means of an ultrasonic emulsifier.

The polymerizable monomer composition for core was added to the magnesium hydroxide colloidal dispersion (the magnesium hydroxide colloid amount: 5.3 parts), and the mixture was further stirred. Then, as a polymerization initiator, 6 parts of t-butylperoxy-2-ethyl butanoate was added thereto. The dispersion mixed with the polymerization initiator was dispersed at a rotational frequency of 15,000 rpm by an in-line type emulsifying and dispersing machine (manufactured by Pacific Machinery & Engineering Co., Ltd, product name: MILDER) to form the polymerizable monomer composition for core into droplets.

The dispersion containing the droplets of the polymerizable monomer composition, was put in a reactor, and the temperature of the dispersion was raised to 90° C. to initiate a polymerization reaction. After a polymerization conversion rate of almost 100% was reached, a solution prepared by dissolving, as a polymerization initiator for shell, 0.1 parts of 2,2′-azobis[2-methyl-N-(2-hydroxyethyl)-propionamide] (product name: VA-086, manufactured by Wako Pure Chemical Industries, Ltd., a water-soluble initiator) in the aqueous dispersion of the polymerizable monomer for shell, was added to the reactor. Next, the polymerization reaction was further continued by maintaining the dispersion temperature at 95° C. for 4 hours. Then, the polymerization reaction was stopped by water cooling, thereby obtaining an aqueous dispersion of core-shell type colored resin particles.

The aqueous dispersion of the colored resin particles was subjected to acid washing (25° C., 10 minutes) by adding, while stirring the aqueous dispersion, sulfuric acid to the dispersion until the pH of the dispersion reached 4.5 or less. Then, the colored resin particles were separated by filtration and washed with water. The washing water was filtered. The electric conductivity of the filtrate at this time was 20 μS/cm. Furthermore, the colored resin particles subjected to the washing and filtering steps were dehydrated and dried to obtain dried colored resin particles.

The volume average particle diameter (Dv) of the obtained colored resin particles was 7.10 μm; the particle size distribution (Dv/Dn) of the obtained colored resin particles was 1.12; and the average circularity of the obtained colored resin particles was 0.990.

To 100 parts of the obtained colored resin particles, 0.2 parts of the silicone resin particles 1, 0.80 parts of the silica particles A1, and 0.80 parts of the silica particles B1 were added. They were mixed by means of a high-speed mixing machine (manufactured by NIPPON COKE & ENGINEERING CO., LTD., product name: FM MIXER) to add the external additives on the surface of the colored resin particles, thereby producing a yellow toner Y1. The properties of the yellow toner Y1 are shown in Table 2.

### (2) Production Examples Y2 to Y4

yellow toners Y2 to Y4 were produced in the same manner as Production Example Y1, except that the amount of the added silicone resin particles 1, that of the added silica particles A1 and that of the added silica particles B1 were changed as shown in Table 2. The properties of the yellow toners Y2 to Y4 are shown in Table 2.

### 2-2. Magenta Toner

### (1) Production Example a1

First, 23.2 kg of cyclohexane, 1.5 mmol of N,N,N′,N′-tetramethylethylenediamine (TMEDA) and 1.70 kg of styrene were put in a pressure-resistant reactor and stirred at 40° C. While stirring them at 40° C., 99.1 mmol of n-butyllithium was added thereto. With increasing the temperature of the obtained mixture to 50° C., the mixture was polymerized for one hour. The polymerization conversion rate of the styrene was 100% by mass. With controlling the temperature of the mixture at 50° C. to 60° C., 6.03 kg of isoprene was continuously added to the reactor for one hour. After the addition of the isoprene was completed, the mixture was further polymerized for one hour, thereby forming a styrene-isoprene diblock copolymer. The polymerization conversion rate of the isoprene was 100% by mass. Next, 15.0 mmol of dimethyldichlorosilane was added thereto as a coupling agent to initiate a coupling reaction, and the coupling reaction was continued for two hours, thereby forming a styrene-isoprene-styrene triblock copolymer. Then, 198 mmol of methanol was added thereto as a polymerization inhibitor, and they were mixed well to stop the reaction, thereby obtaining a reaction solution containing a block copolymer composition. Then, to 100 parts of the thus-obtained reaction solution (containing 30 parts of a polymer component), 0.3 parts of 2,6-di-tert-butyl-p-cresol was added as an antioxidant. They were mixed to obtain a mixed solution, and the mixed solution was gradually added in a dropwise manner to a hot water at 85° C. to 95° C. to vaporize the solvent, thereby obtaining precipitates. The precipitates were pulverized and dried by hot air at 85° C., thereby recovering the block copolymer composition. The styrene monomer unit contained in the obtained block copolymer composition (a styrene-based thermoplastic elastomer (a)) was 24% by mass, and the weight average molecular weight Mw of the styrene-based thermoplastic elastomer (a) was 106,000.

### (2) Production Example M1

First, 74 parts of styrene, 26 parts of n-butyl acrylate and 0.1 parts of a polymethacrylic acid ester macromonomer (product name: AA6; manufactured by: TOAGOSEI Co., Ltd.; Tg: 94° C.) as polymerizable monomers, 0.50 parts of tetraethylthiuram disulfide as a molecular weight modifier, and 8.0 parts of a magenta pigment A (a mixed crystal of C.I. Pigment Red 122 and C.I. Pigment Violet 19 at a mass ratio of 1:1) as a colorant, were wet-pulverized by means of a media-type disperser (product name: PICOMILL, manufactured by: ASADA IRON WORKS. Co., Ltd.)

To the mixture obtained by the wet pulverization, 10.0 parts of a charge control resin (a quaternary ammonium salt-containing styrene-acrylic resin, functional group amount: 1% by mass), 12.0 parts of a synthetic ester wax 1 (hexaglycerin octabehenate, melting point: 70° C.) and 2.0 parts of the styrene-based thermoplastic elastomer (a) obtained in Production Example a1 as a styrene-based thermoplastic elastomer were added, mixed and dissolved to prepare a polymerizable monomer composition for core.

Also, an aqueous solution in which 7.3 parts of sodium hydroxide was dissolved in 50 parts of ion exchanged water, was gradually added under stirring to an aqueous solution in which 10.4 parts of magnesium chloride was dissolved in 280 parts of ion exchanged water, whereby a magnesium hydroxide colloidal dispersion was prepared.

Also, an aqueous dispersion of a polymerizable monomer for shell was prepared by finely dispersing 2 parts of methyl methacrylate and 130 parts of water by means of an ultrasonic emulsifier.

The polymerizable monomer composition for core was added to the magnesium hydroxide colloidal dispersion (the magnesium hydroxide colloid amount: 5.3 parts), and the mixture was further stirred. Then, as a polymerization initiator, 6 parts of t-butylperoxy-2-ethyl butanoate was added thereto. The dispersion mixed with the polymerization initiator was dispersed at a rotational frequency of 15,000 rpm by an in-line type emulsifying and dispersing machine (manufactured by Pacific Machinery & Engineering Co., Ltd, product name: MILDER) to form the polymerizable monomer composition for core into droplets.

The dispersion containing the droplets of the polymerizable monomer composition, was put in a reactor, and the temperature of the dispersion was raised to 90° C. to initiate a polymerization reaction. After a polymerization conversion rate of almost 100% was reached, a solution prepared by dissolving, as a polymerization initiator for shell, 0.1 parts of 2,2′-azobis[2-methyl-N-(2-hydroxyethyl)-propionamide] (product name: VA-086, manufactured by Wako Pure Chemical Industries, Ltd., a water-soluble initiator) in the aqueous dispersion of the polymerizable monomer for shell, was added to the reactor. Next, the polymerization reaction was further continued by maintaining the dispersion temperature at 95° C. for 4 hours. Then, the polymerization reaction was stopped by water cooling, thereby obtaining an aqueous dispersion of core-shell type colored resin particles.

The aqueous dispersion of the colored resin particles was subjected to acid washing (25° C., 10 minutes) by adding, while stirring the aqueous dispersion, sulfuric acid to the dispersion until the pH of the dispersion reached 4.5 or less. Then, the colored resin particles were separated by filtration and washed with water. The washing water was filtered. The electric conductivity of the filtrate at this time was 20 μS/cm. Furthermore, the colored resin particles subjected to the washing and filtering steps were dehydrated and dried to obtain dried colored resin particles.

The volume average particle diameter (Dv) of the obtained colored resin particles was 7.32 μm; the particle size distribution (Dv/Dn) of the obtained colored resin particles was 1.13; and the average circularity of the obtained colored resin particles was 0.990.

To 100 parts of the obtained colored resin particles, 1.0 part of the silica particles A1 and 1.0 part of the silica particles B1 were added. They were mixed by means of a high-speed mixing machine (manufactured by NIPPON COKE & ENGINEERING CO., LTD., product name: EM MIXER) to add the external additives on the surface of the colored resin particles, thereby producing a magenta toner M1. The properties of the magenta toner M1 are shown in Table 2.

### (2) Production Examples M2 and M3

Magenta toners M2 and M3 were produced in the same manner as Production Example M1, except that the amount of the added silicone resin particles 1, that of the added silica particles A1 and that of the added silica particles B1 were changed as shown in Table 2. The properties of the magenta toners M2 and M3 are shown in Table 2.

### 2-3. Cyan Toner

### (1) Production Example C1

First, 75 parts of styrene, 25 parts of n-butyl acrylate and 0.1 parts of a polymethacrylic acid ester macromonomer (product name: AA6; manufactured by: TOAGOSEI Co., Ltd.; Tg: 94° C.) as polymerizable monomers, 1.95 parts of tetraethylthiuram disulfide as a molecular weight modifier, and 6 parts of C.I. Pigment Blue 15:3 as a colorant, were wet-pulverized by means of a media-type disperser (product name: PICOMILL, manufactured by: ASADA IRON WORKS. Co., Ltd.)

To the mixture obtained by the wet pulverization, 13 parts of a charge control resin (a quaternary ammonium salt-containing styrene-acrylic resin, functional group amount: 1% by mass) and parts of a synthetic ester wax (pentaerythritol tetrabehenate, melting point: 76° C.) were added, mixed and dissolved to prepare a polymerizable monomer composition for core.

Also, an aqueous solution in which 7.3 parts of sodium hydroxide was dissolved in 50 parts of ion exchanged water, was gradually added under stirring to an aqueous solution in which 10.4 parts of magnesium chloride was dissolved in 280 parts of ion exchanged water, whereby a magnesium hydroxide colloidal dispersion was prepared.

Also, an aqueous dispersion of a polymerizable monomer for shell was prepared by finely dispersing 2 parts of methyl methacrylate and 130 parts of water by means of an ultrasonic emulsifier.

The polymerizable monomer composition for core was added to the magnesium hydroxide colloidal dispersion (the magnesium hydroxide colloid amount: 5.3 parts), and the mixture was further stirred. Then, as a polymerization initiator, 6 parts of t-butylperoxy-2-ethyl butanoate was added thereto. The dispersion mixed with the polymerization initiator was dispersed at a rotational frequency of 15,000 rpm by an in-line type emulsifying and dispersing machine (manufactured by Pacific Machinery & Engineering Co., Ltd, product name: MILDER) to form the polymerizable monomer composition for core into droplets.

The dispersion containing the droplets of the polymerizable monomer composition, was put in a reactor, and the temperature of the dispersion was raised to 90° C. to initiate a polymerization reaction. After a polymerization conversion rate of almost 100% was reached, a solution prepared by dissolving, as a polymerization initiator for shell, 0.1 parts of 2,2′-azobis[2-methyl-N-(2-hydroxyethyl)-propionamide] (product name: VA-086, manufactured by Wako Pure Chemical Industries, Ltd., a water-soluble initiator) in the aqueous dispersion of the polymerizable monomer for shell, was added to the reactor. Next, the polymerization reaction was further continued by maintaining the dispersion temperature at 95° C. for 4 hours. Then, the polymerization reaction was stopped by water cooling, thereby obtaining an aqueous dispersion of core-shell type colored resin particles.

The aqueous dispersion of the colored resin particles was subjected to acid washing (25° C., 10 minutes) by adding, while stirring the aqueous dispersion, sulfuric acid to the dispersion until the pH of the dispersion reached 4.5 or less. Then, the colored resin particles were separated by filtration and washed with water. The washing water was filtered. The electric conductivity of the filtrate at this time was 20 μS/cm. Furthermore, the colored resin particles subjected to the washing and filtering steps were dehydrated and dried to obtain dried colored resin particles.

The volume average particle diameter (Dv) of the obtained colored resin particles was 7.25 μm; the particle size distribution (Dv/Dn) of the obtained colored resin particles was 1.13; and the average circularity of the obtained colored resin particles was 0.992.

To 100 parts of the obtained colored resin particles, 1.20 parts of the silica particles A1 and 1.20 parts of the silica particles B1 were added. They were mixed by means of a high-speed mixing machine (manufactured by NIPPON COKE & ENGINEERING CO., LTD., product name: FM MIXER) to add the external additives on the surface of the colored resin particles, thereby producing a cyan toner C1. The properties of the cyan toner C1 are shown in Table 2.

### (2) Production Example C2

A cyan toner C2 was produced in the same manner as Production Example C1, except that the amount of the added silicone resin particles 1, that of the added silica particles A1 and that of the added silica particles B1 were changed as shown in Table 2. The properties of the cyan toner C2 are shown in Table 2.

TABLE 2

| | | Yellow toner | | | | Magenta toner | | | Cyan toner | |
|---|---|---|---|---|---|---|---|---|---|---|
| | | Y1 | Y2 | Y3 | Y4 | M1 | M2 | M3 | C1 | C2 |
| Internal friction angle | | 20.3 | 19.7 | 21.4 | 18.1 | 22.0 | 22.7 | 19.7 | 22.6 | 20.6 |
| of toner θ (°) | | | | | | | | | | |
| Colored | Amount | 100.0 | 100.0 | 100.0 | 100.0 | 100.0 | 100.0 | 100.0 | 100.0 | 100.0 |
| resin | (parts by mass) | | | | | | | | | |
| particles | Volume average | 7.10 | 7.10 | 7.10 | 7.10 | 7.32 | 7.32 | 7.32 | 7.25 | 7.25 |
| | particle diameter | | | | | | | | | |
| | Dv (μm) | | | | | | | | | |
| | Number average | 6.35 | 6.35 | 6.35 | 6.35 | 6.47 | 6.47 | 6.47 | 6.40 | 5.40 |
| | particle diameter | | | | | | | | | |
| | Dn (μm) | | | | | | | | | |
| | Dv/Dn | 1.12 | 1.12 | 1.12 | 1.12 | 1.13 | 1.13 | 1.13 | 1.13 | 1.13 |
| | Average | 0.990 | 0.990 | 0.990 | 0.990 | 0.990 | 0.990 | 0.990 | 0.092 | 0.992 |
| | circularity | | | | | | | | | |
| Silicone | Particles No. | Particles 1 | Particles 1 | None | Particles 1 | None | None | Particles 1 | None | Particles 1 |
| resin | Amount | 0.2 | 0.4 | — | 0.2 | — | — | 0.2 | — | 0.2 |
| particles | (pass by mass) | | | | | | | | | |
| Silica | Particles No. | Particles | Particles | Particles | Particles | Particles | Particles | Particles | Particles | Particles |
| particles A | | A1 | A1 | A1 | A1 | A1 | A1 | A1 | A1 | A1 |
| | Amount | 0.80 | 0.80 | 5.80 | 0.50 | 1.00 | 1.20 | 1.00 | 1.20 | 1.00 |
| | (parts by mass) | | | | | | | | | |
| Silica | Particles No. | Particles | Particles | Particles | Particles | Particles | Particles | Particles | Particles | Particles |
| particles B | | B1 | B1 | B1 | B1 | B1 | B1 | B1 | B1 | B1 |
| | Amount | 0.80 | 0.80 | 0.80 | 0.50 | 1.00 | 1.20 | 1.00 | 1.20 | 1.00 |
| | (parts by mass) | | | | | | | | | |

### 2-4. Combination of Toners

Toner sets were each prepared by combining any one of the yellow toners Y1 to Y4 and the cyan toner C2 as the initial color toner, and any one of the magenta toners M1 to M3 and the cyan toner C1 as the other color toner. The toner combinations of the toner sets are shown in Table 3.

TABLE 3

| | | Example 1 | Example 2 | Example 3 | Example 4 |
|---|---|---|---|---|---|
| Initial color | Type | Y1 | Y2 | Y1 | Y1 |
| toner | Internal friction angle θ1 (°) | 20.3 | 19.7 | 20.3 | 20.3 |
| | Average circularity of | 0.990 | 0.990 | 0.990 | 0.990 |
| | colored resin particles | | | | |
| Other color | Type | M1 | M1 | M2 | C1 |
| toner | Internal friction angle θ2 (°) | 22.0 | 22.0 | 22.7 | 22.6 |
| | Average circularity of | 0.990 | 0.990 | 0.990 | 0.992 |
| | colored resin particles | | | | |
| Difference between internal friction | | 1.7 | 2.3 | 2.4 | 2.3 |
| angles θ2 − θ1 (°) | | | | | |
| Silicone resin | Type | Particles 1 | Particles 1 | Particles 1 | Particles 1 |
| particles | Number average particle | 0.09 | 0.09 | 0.09 | 0.09 |
| | diameter Dn (μm) | | | | |
| | Theoretical specific surface | 50 | 50 | 50 | 50 |
| | area TS (m²/g) | | | | |
| | BET specific surface area | 230 | 230 | 230 | 230 |
| | BS (m²/g) | | | | |
| | Ratio (BS/TS) | 4.6 | 4.6 | 4.6 | 4.6 |
| | Dv90/Dv50 | 2.2 | 2.2 | 2.2 | 2.2 |
| | Form | Spherical | Spherical | Spherical | Spherical |
| | Sphericity (Sc/Sr) | 0.988 | 0.988 | 0.988 | 0.988 |
| | Water adsorption amount (%) | 0.35 | 0.35 | 0.35 | 0.35 |
| | Amount of the silicone resin | 0.20 | 0.40 | 0.20 | 0.20 |
| | particles added in the initial | | | | |
| | color toner (parts by mass) | | | | |
| | Amount of the silicone resin | 0 | 0 | 0 | 0 |
| | particles added in the other | | | | |
| | color toner (parts by mass) | | | | |
| Silica | Type | A1 | A1 | A1 | A1 |
| particles A | Number average particle | 20 | 20 | 20 | 20 |
| | diameter Dn (μm) | | | | |
| | Amount of the silica particles | 0.80 | 0.80 | 0.80 | 0.80 |
| | A added in the initial | | | | |
| | color toner (parts by mass) | | | | |
| | Amount of the silica particles | 1.00 | 1.00 | 1.20 | 1.20 |
| | A added in the other color | | | | |
| | toner (parts by mass) | | | | |
| | Ratio of the amount of the | 1.25 | 1.25 | 1.50 | 1.50 |
| | silica particles A in the other | | | | |
| | color toner to the amount of | | | | |
| | the silica particles A in the | | | | |
| | initial color toner | | | | |
| Silica | Type | B1 | B1 | B1 | B1 |
| particles B | Number average particle | 50 | 50 | 50 | 50 |
| | diameter Dn (μm) | | | | |
| | Amount of the silica particles | 0.80 | 0.80 | 0.80 | 0.80 |
| | B added in the initial color | | | | |
| | toner (parts by mass) | | | | |
| | Amount of the silica particles | 1.00 | 1.00 | 1.20 | 1.20 |
| | B added in the other color | | | | |
| | toner (parts by mass) | | | | |
| | Ratio of the amount of the | 1.25 | 1.25 | 1.50 | 1.50 |
| | silica particles B in the other | | | | |
| | color toner to the amount of | | | | |
| | the silica particles B in | | | | |
| | the initial color toner | | | | |
| Evaluation | Number of sheets printed until | 10,000< | 7,000 | 9,000 | 10,000< |
| results | the appearance of a vertical | | | | |
| | streak (the initial color toner) | | | | |
| | Number of sheets printed until | 9,000 | 9,000 | 7,000 | 7,000 |
| | the appearance of a vertical | | | | |
| | steak (the other color toner) | | | | |
| | Number of sheets printed until | 9,000 | 10,000< | 7,000 | 9,000 |
| | the appearance of print density | | | | |
| | unevenness (the initial color) | | | | |
| | Number of sheets printed until | 9,000 | 9,000 | 7,000 | 7,000 |
| | the appearance of print density | | | | |
| | unevenness (the other color) | | | | |
| | Number of sheets printed until | 9,000 | 10,000< | 9,000 | 9,000 |
| | the appearance of fog | | | | |
| | (the inital color) | | | | |
| | Number of sheets printed until | 9,000 | 9,000 | 10,000< | 10,000< |
| | the appearance of fog | | | | |
| | (the other color) | | | | |
| | Number of sheets printed until | 9,000 | 7,000 | 7,000 | 7,000 |
| | the appearance of a printing | | | | |
| | failure (the above evaluation | | | | |
| | items are all OK) | | | | |
| | Secondary color reproducibility | Lv. 4 | Lv. 4 | Lv. 4 | Lv. 4 |
| | | | Comparative | Comparative | Comparative |
| | | Example 5 | Example 1 | Example 2 | Example 3 |
| Initial color | Type | C2 | Y3 | Y1 | Y4 |
| toner | Internal friction angle θ1 (°) | 20.0 | 21.4 | 20.3 | 18.1 |
| | Average circularity of | 0.992 | 0.990 | 0.990 | 0.990 |
| | colored resin particles | | | | |
| Other color | Type | M1 | M1 | M3 | M2 |
| toner | Internal friction angle θ2 (°) | 22.0 | 22.0 | 19.7 | 22.7 |
| | Average circularity of | 0.990 | 0.990 | 0.990 | 0.990 |
| | colored resin particles | | | | |
| Difference between internal friction | | 1.4 | 0.6 | −0.6 | 4.6 |
| angles θ2 − θ1 (°) | | | | | |
| Silicone resin | Type | Particles 1 | None | Particles 1 | Particles 1 |
| particles | Number average particle | 0.09 | — | 0.09 | 0.09 |
| | diameter Dn (μm) | | | | |
| | Theoretical specific surface | 50 | — | 50 | 50 |
| | area TS (m²/g) | | | | |
| | BET specific surface area | 230 | — | 230 | 230 |
| | BS (m²/g) | | | | |
| | Ratio (BS/TS) | 4.6 | — | 4.6 | 4.6 |
| | Dv90/Dv50 | 2.2 | — | 2.2 | 2.2 |
| | Form | Spherical | — | Spherical | Spherical |
| | Sphericity (Sc/Sr) | 0.988 | — | 0.988 | 0.988 |
| | Water adsorption amount (%) | 6.35 | — | 0.36 | 0.35 |
| | Amount of the silicone resin | 0.20 | 0 | 0.20 | 0.20 |
| | particles added in the initial | | | | |
| | color toner (parts by mass) | | | | |
| | Amount of the silicone resin | 0 | 0 | 0.20 | 0 |
| | particles added in the other | | | | |
| | color toner (parts by mass) | | | | |
| Silica | Type | A1 | A1 | A1 | A1 |
| particles A | Number average particle | 20 | 20 | 20 | 20 |
| | diameter Dn (μm) | | | | |
| | Amount of the silica particles | 1.00 | 0.80 | 0.80 | 0.50 |
| | A added in the initial | | | | |
| | color toner (parts by mass) | | | | |
| | Amount of the silica particles | 1.00 | 1.00 | 1.00 | 1.20 |
| | A added in the other color | | | | |
| | toner (parts by mass) | | | | |
| | Ratio of the amount of the | 1.00 | 1.25 | 1.25 | 2.40 |
| | silica particles A in the other | | | | |
| | color toner to the amount of | | | | |
| | the silica particles A in the | | | | |
| | initial color toner | | | | |
| Silica | Type | B1 | B1 | B1 | B1 |
| particles B | Number average particle | 50 | 50 | 50 | 50 |
| | diameter Dn (μm) | | | | |
| | Amount of the silica particles | 1.00 | 0.80 | 0.80 | 0.50 |
| | B added in the initial color | | | | |
| | toner (parts by mass) | | | | |
| | Amount of the silica particles | 1.00 | 1.00 | 1.00 | 1.20 |
| | B added in the other color | | | | |
| | toner (parts by mass) | | | | |
| | Ratio of the amount of the | 1.00 | 1.25 | 1.25 | 2.40 |
| | silica particles B in the other | | | | |
| | color toner to the amount of | | | | |
| | the silica particles B in | | | | |
| | the initial color toner | | | | |
| Evaluation | Number of sheets printed until | 10,000< | 10,000< | 10,000< | 10,000< |
| results | the appearance of a vertical | | | | |
| | streak (the initial color toner) | | | | |
| | Number of sheets printed until | 9,000 | 9,000 | 7,000 | 7,000 |
| | the appearance of a vertical | | | | |
| | steak (the other color toner) | | | | |
| | Number of sheets printed until | 9,000 | 6,000 | 7,000 | 10,000< |
| | the appearance of print density | | | | |
| | unevenness (the initial color) | | | | |
| | Number of sheets printed until | 9,000 | 9,000 | 10,000< | 7,000 |
| | the appearance of print density | | | | |
| | unevenness (the other color) | | | | |
| | Number of sheets printed until | 8,000 | 6,000 | 9,000 | 5,000 |
| | the appearance of fog | | | | |
| | (the inital color) | | | | |
| | Number of sheets printed until | 9,000 | 9,000 | 10,000< | 10,000< |
| | the appearance of fog | | | | |
| | (the other color) | | | | |
| | Number of sheets printed until | 8,000 | 6,000 | 7,000 | 5,000 |
| | the appearance of a printing | | | | |
| | failure (the above evaluation | | | | |
| | items are all OK) | | | | |
| | Secondary color reproducibility | Lv. 4 | Lv. 2 | Lv. 1 | Lv. 5 |

### 3. Physical Properties Testing Methods

### 3-1. Measurement of the Particle Diameter of the Colored Resin Particles

The volume average particle diameter (Dv), number average particle diameter (Dn) and particle size distribution (Dv/Dn) of the colored resin particles were measured by means of a particle size analyzer (product name: MULTISIZER, manufactured by: Beckman Coulter, Inc.) The measurement by means of MULTISIZER was carried out in the following condition:

Aperture diameter: 100 μm

Dispersion medium: ISOTON II (: product name)

Concentration: 10%

The number of measured particles: 100,000 particles.

More specifically, about 0.1 g of the colored resin particles were weighed out and put in a beaker. Next, as a dispersant, 0.1 mL of a surfactant aqueous solution (product name: DRIWEL, manufactured by: Fujifilm Corporation) was added thereto. In addition, 10 mL to 30 mL of ISOTON II was put in the beaker. The mixture was dispersed for 3 minutes with a 20 W (watt) ultrasonic disperser. Then, the above-mentioned measurement by means of the particle size analyzer was carried out.

### 3-2. Calculation of the Average Circularity of the Colored Resin Particles

The average circularity of the colored resin particles is a value obtained by measuring the colored resin particles in an aqueous dispersion system by means of a flow type particle image analyzer (product name: FPIA-3000, manufactured by: Sysmex Corporation). The average circularity was measured by the following method: 10 mL of ion-exchanged water was prepared in a container; as a dispersant, a surfactant (alkylbenzene sulfonate) was added thereto; and then, 0.2 g of the measurement sample was added thereto and uniformly dispersed.

The dispersion was carried out by using an ultrasonic disperser as a dispersion means, in the following condition:

output: 60 W

Time: Three minutes.

The concentration of the colored resin particles at the time of the measurement was adjusted to be from 3000 particles/μL to 10,000 particles/μL. The circularity was measured for 1000 to 10,000 colored resin particles, and the average circularity was obtained by using the data.

### 3-3. Measurement of the Number Average Particle Diameter of the Silicone Resin Particles

A SEM image was taken by use of an ultra-high resolution field emission scanning electron microscope (product name: SU9000, manufactured by Hitachi High-Technologies Corporation). From the particles shown in the image, 30 particles were randomly selected and their particle diameters were measured. Then, the number average particle diameter of the 30 particles was calculated.

### 3-4. Calculation of the Theoretical Specific Surface Area (TS) of the Silicone Resin Particles

From the number average particle diameter calculated in “3-3. Measurement of the number average particle diameter of the silicone resin particles”, the theoretical specific surface area (TS) was obtained by the theoretical calculation formula for obtaining the specific surface area per unit mass of a sphere.

### 3-5. Measurement of the BET Specific Surface Area (BS) of the Silicone Resin Particles

Using a full automatic BET specific surface area analyzer (product name: MACSORB HM MODEL-1208, manufactured by Mountech Co., Ltd.), the BET specific surface area (BS) was measured by the nitrogen adsorption method (the BET method).

### 3-6. Measurement of the Number Average Particle Diameter of the Silica Particles A and B

First, 0.5 g of the silica particles A were dispersed in 50 mL of water by use of an ultrasonic cleaner (product name: BRANSONIC 1510J, manufactured by Branson Ultrasonics, 42 kHz, 90 W, 2L) to obtain an aqueous dispersion of the particles. The number average particle diameter of the silica particles A was obtained by measuring the aqueous dispersion of the particles with a dynamic light scattering particle size distribution analyzer (product name: LB-550, manufactured by HORIBA, Ltd.) In the same manner as the silica particles A, the number average particle diameter of the silica particles B was obtained.

### 3-7. Measurement of the Internal Friction Angle of Each Toner

The internal friction angle of each toner was obtained by shear stress measurement that was carried out by the following process using FT4 POWDER RHEOMETER (product name, manufactured by Freeman Technology).

A 50 mm×85 mm vessel, which was an accessory component of the powder rheometer, was installed in the powder rheometer, and 15 g of the toner was uniformly introduced into the vessel by use of a sieve. Then, the measurement was carried out by use of blades for 48 mm shear stress measurement, which were dedicated for the device.

Shear loads at vertical loads of 1 kPa, 2 kPa, 4 kPa, 10 kPa, 15 kPa and 20 kPa were measured.

By using the measured values and by having vertical load on the horizontal axis and shear load on the vertical axis, an approximate straight line passing through the origin (X.Y=0.0) was obtained. The angle between the horizontal axis and the approximate straight line was defined as the internal friction angle of the measured toner.

### 4. Methods for Testing Toner Performance

4-1. The Number of Sheets Printed Until the Appearance of a Printing Failure (the Number of Sheets Printed Until the Appearance of Fog, the Number of Sheets Printed Until the Appearance of a Vertical Streak, and the Number of Sheets Printed Until the Appearance of Print Density Unevenness)

A commercially-available, non-magnetic one-component development printer (resolution 600 dpi, printing speed 28 sheets/min) was used, and printing sheets, a developing device containing the initial color toner and a developing device containing the other color toner were set in the printer. The printer was left to stand for 24 hours in a normal temperature and normal humidity (N/N) environment of a temperature of 23° C. and a humidity of 50% RH. Then, in the same environment, at most 10,000 sheets were continuously printed with each color toner at an image density of 5%. Every time 1000 sheets were continuously printed, a set of solid pattern printing at an image density of 0%, solid pattern printing with the initial color toner at an image density of 100%, and solid pattern printing with the other color toner at an image density of 100% was carried out 6 times, and the state of the developing rollers of the printer was checked.

### <Evaluation Criteria of the Number of Sheets Until the Appearance of Fog>

The six printed sheets obtained by the solid pattern printing at an image density of 0%, which was carried out every time 1000 sheets were continuously printed (a total of 6 times), were visually observed. The number of continuously printed sheets at the point when fog of the initial color (Y or C) (i.e., toner transfer onto a non-image area) was found on one or more of the six printed sheets, was considered as the number of sheets printed until the appearance of fog of the initial color (Y or C).

In the same manner as above, the six printed sheets obtained by the solid pattern printing at an image density of 0%, which was carried out every time 1000 sheets were continuously printed (a total of 6 times), were visually observed. The number of continuously printed sheets at the point when fog of the other color (M or C) (i.e., toner transfer onto a non-image area) was found on one or more of the six printed sheets, was considered as the number of sheets printed until the appearance of fog of the other color (M or C).

### <Evaluation Criteria of the Number of Sheets Printed Until the Appearance of a Vertical Streak>

The six printed sheets obtained by the solid pattern printing at an image density of 0%, which was carried out every time 1000 sheets were continuously printed (a total of 6 times), and the six printed sheets obtained by the solid pattern printing with the initial color (Y or C) toner at an image density of 100%, which was carried out every time 1000 sheets were continuously printed (a total of 6 times), were visually observed. The number of continuously printed sheets at the earlier one of the point when a streak of the initial color (Y or C) was found on two or more of the six printed sheets obtained by the solid pattern printing at an image density of 0% and the point when a streak was found on two or more of the six printed sheets obtained by the solid pattern printing with the initial color (Y or C) toner at an image density of 100%, was considered as the number of sheets printed until the appearance of a vertical streak of the initial color (Y or C).

In the same manner as above, the six printed sheets obtained by the solid pattern printing at an image density of 0%, which was carried out every time 1000 sheets were continuously printed (a total of 6 times), and the six printed sheets obtained by the solid pattern printing with the other color (M or C) toner at an image density of 100%, which was carried out every time 1000 sheets were continuously printed (a total of 6 times), were visually observed. The number of continuously printed sheets at the earlier one of the point when a streak of the other color (M or C) was found on two or more of the six printed sheets obtained by the solid pattern printing at an image density of 0% and the point when a streak was found on two or more of the six printed sheets obtained by the solid pattern printing with the other color (M or C) toner at an image density of 100%, was considered as the number of sheets printed until the appearance of a vertical streak of the other color (M or C).

<Evaluation Criteria of the Number of Sheets Printed Until the appearance of Print Density Unevenness>

The six printed sheets obtained by the solid pattern printing with the initial color (Y or C) toner at an image density of 100%, which was carried out every time 1000 sheets were continuously printed (a total of 6 times), were visually observed to select the printed sheets on which image density unevenness was visually confirmed. On each of the selected printed sheets, three dark spots and three light spots were visually specified, and the reflection densities of these spots were measured by use of a reflection densitometer (product name: eXact Basic). For each selected printed sheet, the average of the reflection densities of the three dark spots and the average of the reflection densities of the three light spots were calculated, and the ratio of the average of the reflection densities of the three light spots to the average of the reflection densities of the three dark spots, was calculated. When one or more of the selected printed sheets did not satisfy the following condition, the number of continuously printed sheets at that point was considered as the number of sheets printed until the appearance of print density unevenness of the initial color (Y or C).

(The average of the reflection densities of the three light spots)/(The average of the reflection densities of the three dark spots)≥0.85 Condition:

In the same manner as above, for each of the six printed sheets obtained by the solid pattern printing with the other color toner (M or C) at a printing density of 100%, which was carried out every time 1000 sheets were continuously printed (a total of 6 times), the ratio of the average of the reflection densities of the three light spots to the average of the reflection densities of the three dark spots was calculated. When the above condition was not satisfied, the number of continuously printed sheets at that point was considered as the number of sheets printed until the appearance of print density unevenness of the other color (M or C).

At the point when any one of the above problems occurred, the printing durability test was ended, and the number of continuously printed sheets at that point was considered as the number of sheets printed until the appearance of a printing failure. When the above problems did not occur, the printing durability test was ended at the point when the number of continuously printed sheets reached 10,000 sheets (the maximum number of continuously printed sheets).

### 4-2. Secondary Color Reproducibility

A commercially-available, non-magnetic one-component development printer (resolution 600 dpi, printing speed 28 sheets/min) was used. Printing sheets were set in the printer, and color toners were put in the developing devices of the printer. The printer was left to stand for 24 hours in a normal temperature and normal humidity (N/N) environment of a temperature of 23° C. and a humidity of 50% RH. Then, in the same environment, solid pattern printing of a secondary color at a printing density of 100% was carried out by overprinting.

The vertical and horizontal center point of the printed sheet obtained by the solid pattern printing of the secondary color at a printing density of 100%, was used as the reference, and L* (lightness), a* and b* (chromaticity) of three points on the right side of the center point of the printed sheet and those of three points on the left side of the center point of the printed sheet (i.e., a total of 6 points) were measured. From the obtained values, a color difference ΔE was obtained by the following formula. Then, the secondary color reproducibility was evaluated based on the following criteria.

ΔE=√((Reference L*−Measured L*)\hat{ }2+(Reference a*−Measured a*)\hat{ }2+(Reference b*−Measured b*)\hat{ }2 <Secondary color reproducibility calculation formula>

### <Evaluation Criteria>

Lv. 1: Secondary color unevenness is visually apparent.
Lv. 2: Secondary color unevenness is not visually apparent; however, there is a point where the maximum value of ΔE is 8 or more.
Lv. 3: The maximum value of ΔE is 4 or more and less than 8.
Lv. 4: The maximum value of ΔE is 2 or more and less than 4.
Lv. 5: The maximum value of ΔE is less than 2.

### 5. Evaluation Results

Table 3 shows the evaluation results of the printing test that was carried out by use of the toner sets.

In Examples 1 to 5, the internal friction angle θ1 of the initial color toner and the internal friction angle θ2 of the other color toner satisfied the relationships represented by the following formulae (1) and (2), and θ1 and θ2 are in the ranges mentioned below.

θ1<θ2 Formula (1):

1°≤θ2−θ1≤3° Formula (2):

17°≤θ1≤20°

20°≤θ2≤23°

In the toner sets of Examples 1 to 5, both the initial color toner and the different color toner can print 7000 to 9000 sheets without any failure and without the occurrence of a vertical streak, color unevenness or fog. Accordingly, the toner sets of Examples 1 to 5 had superior printing durability. Also, the toner sets of Examples 1 to 5 had superior secondary color reproducibility since their secondary color reproducibility reached Level 4.

In the toner set of Example 1, the yellow toner Y1 (the initial color) contained, as external additives, 0.20 parts of the silicone resin particles 1 with respect to 100 parts of the colored resin particles, and 0.80 parts of the silica particles A1 and 0.80 parts of the silica particles B1 with respect to 100 parts of the colored resin particles; the magenta toner M1 (the other color toner) contained, as external additives, no silicone resin particles 1, and 1.00 part of the silica particles A1 and 1.00 part of the silica particles B1 with respect to 100 parts of the colored resin particles. The ratio of the amount of the silica particles A1 in the other color toner to the amount of the silica particles A1 in the initial color toner was 1.25, and the ratio of the amount of the silica particles B1 in the other color toner to the amount of the silica particles B1 in the initial color toner was 1.25.

The results of the test items (vertical streak, print density unevenness and fog) of the toner set of Example 1 are as follows: the number of sheets printed until the appearance of a vertical streak (the initial color) was more than 10000; the number of sheets until the appearance of print density unevenness was 9000; and the number of sheets until the appearance of fog was 9000. As a result, the number of sheets printed until the appearance of a printing failure was 9000, and among the examples, Example 1 had the best balance between all the test items relating to printing durability.

When compared to Example 1, in the toner set of Example 2, the yellow toner Y2 was used as the initial color toner, and the magenta toner M1, which is the same as Example 1, was used as the other color toner. In the toner set of Example 2, the yellow toner Y2 contained 0.40 parts of the silicone resin particles 1 with respect to 100 parts of the colored resin particles, and the amount of the contained silicone resin particles 1 was larger than the yellow toner Y1 of Example 1. Accordingly, the internal friction angle θ1 of the initial color toner was small. Due to its influence, the number of sheets printed until the appearance of print density unevenness (the initial color) and the number of sheets printed until the appearance of fog (the initial color) were increased; however, the number of sheets printed until the appearance of a vertical streak (the initial color) was 7000. As a result, the number of sheets printed until the appearance of a printing failure was 7000.

When compared to Example 1, in the toner set of Example 3, the yellow toner Y1, which is the same as Example 1, was used as the initial color toner, and the magenta toner M2 was used as the other color toner. In the toner set of Example 3, the magenta toner M2 contained, as external additives, no silicone resin particles 1, 1.20 parts of the silica particles A1 and 1.20 parts of the silica particles B1 with respect to 100 parts of the colored resin particles; the ratio of the amount of the silica particles A1 in the other color toner to the amount of the silica particles A1 in the initial color toner was 1.50; and the ratio of the silica particles B1 in the other color toner to the amount of the silica particles B1 in the initial color toner was 1.50. Accordingly, the internal friction angle θ2 of the other color toner was large. Due to its influence, the number of sheets printed until the appearance of fog (the other color) was increased; however, the number of sheets printed until the appearance of a vertical streak (the initial color) was 9000, and the number of sheets printed until the appearance of a vertical streak (the other color), the number of sheets printed until the appearance of print density unevenness (the initial color) and the number of sheets printed until the appearance of print density unevenness (the other color) were 7000 each. As a result, the number of sheets printed until the appearance of a printing failure was 7000.

When compared to Example 1, in the toner set of Example 4, the yellow toner Y1, which is the same as Example 1, was used as the initial color toner, and the cyan toner C1 was used as the other color toner. In the toner set of Example 4, the cyan toner C1 contained, as external additives, no silicone resin particles 1, 1.20 parts of the silica particles A1 and 1.20 parts of the silica particles B1 with respect to 100 parts of the colored resin particles; the ratio of the amount of the silica particles A1 in the other color toner to the amount of the silica particles A1 in the initial color toner was 1.50; and the ratio of the amount of the silica particles B1 in the other color toner to the amount of the silica particles B1 in the initial color toner was 1.50. Accordingly, the internal friction angle θ2 of the other color toner was large. Due to its influence, the number of sheets printed until the appearance of fog (the other color) was increased; however, the number of sheets printed until the appearance of a vertical streak (the other color) and the number of sheets printed until the appearance of print density unevenness (the other color) were 7000 each. As a result, the number of sheets printed until the appearance of a printing failure was 7000.

When compared to Example 1, in the toner set of Example 5, the cyan toner C2 was used as the initial color toner, and the magenta toner M1, which is the same as Example 1, was used as the other color toner. In the toner set of Example 5, the material composition of the cyan toner C2 (the initial color) was other from the material composition of the initial color toner Y1 of Example 1. Accordingly, the internal friction angle θ1 of the initial color toner was large. Also, the cyan toner C2 (the initial color) contained 1.00 part of the silica particles A1 and 1.00 part of the silica particles B1 with respect to 100 parts of the colored resin particles. Accordingly, the ratio of the amount of the silica particles A1 added to the other color toner to the amount of the silica particles A1 added to the initial color toner (the amount of the silica particles A1 in the other color toner/the amount of the silica particles A1 in the initial color toner) was 1.00, and the ratio of the amount of the silica particles B1 added to the other color toner to the amount of the silica particles B1 added to the initial color toner (the amount of the silica particles B1 in the other color toner/the amount of the silica particles B1 in the initial color toner) was 1.00. These ratios were slightly smaller than those of Example 1. Due to its influence, the number of sheets printed until the appearance of fog (the initial color) was 8000. As a result, the number of sheets printed until the appearance of a printing failure was 8000.

In Comparative Examples 1 to 3, the internal friction angle θ1 of the initial color toner and the internal friction angle θ2 of the other color toner did not satisfy any one or either of the relationships represented by the following formulae (1) or (2). In Comparative Example 1, the internal friction angle θ1 of the initial color toner was out of the range. In Comparative Example 2, both the internal friction angle θ1 of the initial color toner and the internal friction angle θ2 of the other color toner were out of the ranges.

θ1<θ2 Formula (1):

1°≤θ2−θ1≤3° Formula (2):

17°≤θ1≤20°

20°≤2≤23°

The toner sets of Comparative Examples 1 to 3 failed to improve both printing durability and secondary color reproducibility at the same time.

When compared to Example 1, in the toner set of Comparative Example 1, the yellow toner Y3 was used as the initial color toner, and the magenta toner M1, which is the same as Example 1, was used as the other color toner. In the toner set of Comparative Example 1, the yellow toner Y3 did not contain the silicone resin particles 1. Accordingly, the internal friction angle θ1 of the initial color toner was large, and the difference between the internal friction angle θ1 of the initial color toner and the internal friction angle θ2 of the other color toner was less than 1°. Due to its influence, the number of sheets printed until the appearance of print density unevenness (the initial color) was 6000, and the number of sheets printed until the appearance of fog (the initial color) was 6000. As a result, the number of sheets printed until the appearance of a printing failure was 6000. Also, the secondary color reproducibility was at Level 2 and poor.

When compared to Example 1, in the toner set of Comparative Example 2, the yellow toner Y1, which is the same as Example 1, was used as the initial color toner, and the magenta toner M3 was used as the other color toner. In the toner set of Comparative Example 2, the magenta toner M3 (the other color toner) contained 0.20 parts of the silicone resin particles 1 as an external additive, with respect to 100 parts of the colored resin particles. Accordingly, the internal friction angle θ2 of the other color toner was smaller than the internal friction angle θ1 of the initial color toner, and the two internal friction angles θ1 and θ2 did not satisfy the relationship represented by the formula (1). Due to its influence, the number of sheets printed until the appearance of print density unevenness (the other color toner) and the number of sheets printed until the appearance of fog (the other color toner) were increased; however, the number of sheets printed until the appearance of a vertical streak (the other color toner) and the number of sheets printed until the appearance of print density unevenness (the initial color) were 7000 each. As a result, the number of sheets printed until the appearance of a printing failure was 7000. Also, the secondary color reproducibility was at Level 1 and the worst among all the comparative examples.

When compared to Example 1, in the toner set of Comparative Example 3, the yellow toner Y4 was used as the initial color toner, and the magenta toner M2 was used as the other color toner. In the toner set of Comparative Example 3, the yellow toner Y4 (the initial color toner) contained 0.50 parts of the silica particles A1 and 0.50 parts of the silica particles B1 with respect to 100 parts of the colored resin particles; the magenta toner M2 (the other color toner) contained 1.20 parts of the silica particles A1 and 1.20 parts of the silica particles B1 with respect to 100 parts of the colored resin particles; the ratio of the amount of the silica particles A1 in the other color toner to the amount of the silica particles A1 in the initial color toner was 2.40; and the ratio of the amount of the silica particles B1 in the other color toner to the amount of the silica particles B1 in the initial color toner was 2.40. Accordingly, the difference between the internal friction angle θ1 of the initial color toner and the internal friction angle θ2 of the other color toner exceeded 3. Due to its influence, the number of sheets printed until the appearance of print density unevenness (the initial color) and the number of sheets printed until the appearance of fog (the other color) were improved; however, the number of sheets printed until the appearance of a vertical streak (the other color) and the number of sheets printed until the appearance of print density unevenness (the other color) were 7000 each, and the number of sheets printed until the appearance of fog (the initial color) was 5000. As a result, the number of sheets printed until the appearance of a printing failure was 5000.

The secondary color reproducibility of Comparative Example 3 was at Level 5 and superior; however, the number of sheets printed until the appearance of a printing failure thereof was the worst among all the comparative examples.

### REFERENCE SIGNS LIST

100. Image forming device
R. Recording medium
D. Conveying direction
1. Developing device (1Y, 1M, 1C, 1K)
2. Transfer medium (2Y, 2M, 2C, 2K)
3. Support roller (3Y, 3M, 3C, 3K)
4. Conveyor path
5. Exposure device
6. Fixing roller
7. Support roller
11. Photoconductor (11Y, 11M, 11C, 11K)
12. Charging roller (12Y, 12M, 12C, 12K)
13. Laser light irradiator (13Y, 13M, 13C, 13K)
14. Developing section (14Y, 14M, 14C, 14K)
15. Cleaner (15Y, 15M, 15C, 15K)
16. Toner storage (16Y, 16M, 16C, 16K)

1. A color toner set for developing electrostatic images, the toner set comprising a combination of various color toners each of which comprises colored resin particles containing a binder resin, a colorant and a charge control agent, and the combination including at least a yellow toner, a cyan toner and a magenta toner,
wherein, when one color toner selected from the group consisting of the color toners included in the toner set is defined as a first toner and other color toners are defined as second toners, an internal friction angle θ1 (°) of the first toner and an internal friction angle θ2 (°) of each of the second toners satisfy relationships represented by the following formulae (1) and (2):
θ1<θ2 Formula (1):
1°≤θ2−θ1≤3°. Formula (2):

2. The color toner set for developing electrostatic images according to claim 1,
wherein the color toner set is configured to be used in a full-color printer which comprises developing devices corresponding to the color toners included in the toner set and in which primary color images produced by the developing devices are sequentially transferred onto one transfer receptive medium selected from the group consisting of a recording medium and a transfer medium to form an image including a higher-order color on the transfer receptive medium;
wherein the one color toner defined as the first toner is an initial color toner configured to be used in a developing device for producing a primary color image which is transferred first onto the transfer receptive medium; and
wherein the other color toners defined as the second toners are other toners configured to be used in developing devices for producing primary color images which are transferred second or later onto the transfer receptive medium.

3. The color toner set for developing electrostatic images according to claim 1, wherein the first toner is the one color toner selected from the group consisting of the yellow toner, the cyan toner and the magenta toner.

4. The color toner set for developing electrostatic images according to claim 1, wherein the θ1 is 17° or more and 20° or less, and the θ2 is 20° or more and 23° or less.

5. The color toner set for developing electrostatic images according to claim 1,
wherein the first toner comprises, as an external additive, silicone resin particles such that a number average particle diameter thereof is from 0.05 μm to 1.00 μm and a ratio (BS/TS) of a BET specific surface area (BS) measured by a gas adsorption method to a theoretical specific surface area (TS) obtained by a theoretical calculation formula using a number average particle diameter measured by scanning electron microscope (SEM) observation, is in a range of from 3.0 to 30.0, and
wherein the second toners are free of the silicone resin particles.

6. The color toner set for developing electrostatic images according to claim 1,
wherein the first and second toners further comprise, as an external additive, silica particles A which have a number average particle diameter of from 5 nm to 30 nm and of which surface is hydrophobized with at least one hydrophobizing agent selected from the group consisting of a hydrophobizing agent containing an amino group, a silane coupling agent and a silicone oil, and
wherein an amount of the silica particles A contained in each of the second toners is 1.1 or more times an amount of the silica particles A contained in the first toner.

7. The color toner set for developing electrostatic images according to claim 6,
wherein the first and second toners further comprise, as an external additive, silica particles B which have a number average particle diameter of from 31 nm to 200 nm and of which surface is hydrophobized with at least one hydrophobizing agent selected from the group consisting of a hydrophobizing agent containing an amino group, a silane coupling agent and a silicone oil, and
wherein an amount of the silica particles B contained in each of the second toners is 1.1 or more times an amount of the silica particles B contained in the first toner.

8. The color toner set for developing electrostatic images according to claim 1, wherein an average circularity of the colored resin particles of the first and second toners is 0.97 or more and 1.00 or less.

9. A method for forming an image by an electrostatic image development type full-color printer using the color toner set for developing electrostatic images defined by claim 1,
the method comprising:
developing a first image which is a primary color image formed with the first toner,
developing second images which are primary color images formed with the second toners,
forming an image including a higher-order color on a transfer medium by transferring the first image and then the second images onto the transfer medium,
transferring the image including the higher-order color formed on the transfer medium onto a recording medium, and
fixing the image including the higher-order color transferred onto the recording medium on the recording medium.

10. A method for forming an image by an electrostatic image development type full-color printer using the color toner set for developing electrostatic images defined by claim 1,
the method comprising:
developing a first image which is a primary color image formed with the first toner,
developing second images which are primary color images formed with the second toners,
forming an image including a higher-order color on a recording medium by transferring the first image and then the second images onto the recording medium, and
fixing the image including the higher-order color transferred onto the recording medium on the recording medium.

11. The image forming method according to claim 10, wherein the recording medium is paper.
